(19) United States
(12) Patent Application Publication
(10) Pub. No.: US 2026/0357919 A1
(43) Pub. Date: Nov. 12, 2026

(54) VALVE ACTUATOR ASSEMBLY AND METHODS THEREOF

(71) Applicant: Douglas Arthur Newberg, Cincinnati, OH (US)

(72) Inventor: Douglas Arthur Newberg, Cincinnati, OH (US)

(21) Appl. No.: 19/121,697

(22) PCT Filed: Oct. 19, 2023
(86) PCT No.: PCT/US2023/077355

§ 371 Date: Apr. 16, 2025

Related U.S. Application Data
(60) Provisional application No. 63/417,490, filed on Oct. 19, 2022.
(60) Provisional application No. 63/417,492, filed on Oct. 19, 2022.
(60) Provisional application No. 63/417,494, filed on Oct. 19, 2022.
(60) Provisional application No. 63/417,496, filed on Oct. 19, 2022.
(60) Provisional application No. 63/417,500, filed on Oct. 19, 2022.
(60) Provisional application No. 63/417,501, filed on Oct. 19, 2022.
(60) Provisional application No. 63/385,122, filed on Nov. 28, 2022.
(60) Provisional application No. 63/385,774, filed on Dec. 2, 2022.
(60) Provisional application No. 63/539,348, filed on Sep. 20, 2023.
(60) Provisional application No. 63/539,349, filed on Sep. 20, 2023.

(51) Int. Cl. F16K 31/143; F16K 7/12; F16K 41/12

(52) U.S. Cl. CPC F16K 31/143; F16K 7/126; F16K 41/12

(57) ABSTRACT

An actuator assembly includes a perimeter compressor, an actuator shaft, a first actuator, a second actuator and a sealing member. The perimeter compressor is slidable between a retracted position and an extended position. The first actuator is operably coupled with a proximal end of the actuator shaft to facilitate movement of the actuator shaft between the extended position and the retracted position. The sealing member is associated with a distal end of the actuator shaft such that actuation of the actuator shaft between the retracted and extended positions facilitates opening and closing of the sealing member. The second actuator is operably coupled with the perimeter compressor to facilitate movement of the perimeter compressor between the retracted position and the extended position.

### REFERENCE TO RELATED APPLICATIONS

This application claims priority of U.S. provisional patent application Ser. No. 63/417,490, entitled Automated Valve Diaphragm Replacement, filed Oct. 19, 2022; U.S. provisional patent application Ser. No. 63/417,492, entitled Diaphragm Sensor Ring, filed Oct. 19, 2022; U.S. provisional patent application Ser. No. 63/417,494, entitled Disk Diaphragm Valve, filed Oct. 19, 2022; U.S. provisional patent application Ser. No. 63/417,496, entitled Modified Valve Diaphragm Stem Design for Expediting Diaphragm Replacement, filed Oct. 19, 2022; U.S. provisional patent application Ser. No. 63/417,500, entitled Seal Changing Enhancement Kit for Diaphragm Valves and Other Related Valves, filed Oct. 19, 2022; U.S. provisional patent application Ser. No. 63/417,501, entitled Through-Body Valve Diaphragm Access, filed Oct. 19, 2022; U.S. provisional patent application Ser. No. 63/385,122, entitled Actuators with Features for Quick Tall Seal Element Change Out, filed Nov. 28, 2022; U.S. provisional patent application Ser. No. 63/385,774, entitled Seal Changing Enhancement Kit for Diaphragm Valve and Other Related Valves, filed Dec. 2, 2022; U.S. provisional patent application No. 63/539,348, entitled Dual Valve Actuator, filed Sep. 20, 2023; and U.S. provisional patent application No. 63/539,349, entitled Valve Assembly with Independent Perimeter Sealing Subassembly, filed Sep. 20, 2023 and hereby incorporates these provisional patent applications by reference herein in their respective entireties.

### TECHNICAL FIELD

The apparatus and methods described below generally relate to an actuator assembly that is associated with a valve body. The actuator assembly includes a compressor assembly that is movable between an extended position and a retracted position to facilitate removal and replacement of a sealing member (i.e., a diaphragm) while the actuator assembly remains secured to the valve body.

### BACKGROUND

Conventional actuator assemblies are attached to a valve body and include a diaphragm that interfaces with the valve body to control the flow of fluid through the valve body. When the diaphragm needs to be inspected or replaced, the actuator must be removed from the valve body to access the diaphragm which can be time consuming, expensive, and potentially dangerous.

### BRIEF DESCRIPTION OF THE DRAWINGS

Various embodiments will become better understood with regard to the following description, appended claims and accompanying drawings wherein:

FIG. 1 is a front isometric view depicting an actuator assembly in association with a valve body, in accordance with one embodiment;

FIG. 2 is an exploded view of the actuator assembly and the valve body of FIG. 1, wherein the actuator assembly includes an actuator shaft and a compressor assembly;

FIG. 3 is a cross sectional view taken along the line 3-3 in FIG. 1, with the actuator shaft and the compressor assembly both shown in respective extended positions;

FIG. 4 is a cross sectional view of the actuator assembly and the valve body of FIG. 3, but with the actuator shaft shown in a retracted position;

FIG. 5 is a cross sectional view of the actuator assembly and the valve body of FIG. 4, but with the compressor assembly shown in a retracted position;

FIG. 6 is a rear isometric view of the actuator assembly and the valve body of FIG. 5, but with a sealing member removed from between the compressor assembly and the valve body;

FIG. 7 is a front isometric view depicting an actuator assembly and a valve body, in accordance with another embodiment;

FIG. 8 is an exploded view of the actuator assembly and the valve body of FIG. 7, wherein the actuator assembly includes an actuator shaft and a perimeter compressor;

FIG. 9 is a cross sectional view taken along the line 9-9 in FIG. 7, with the actuator shaft and the perimeter compressor both shown in respective extended positions;

FIG. 10 is a cross sectional view of the actuator assembly and the valve body of FIG. 9, but with the actuator shaft shown in a retracted position;

FIG. 11 is a cross sectional view of the actuator assembly and the valve body of FIG. 10, but with the perimeter compressor shown in a retracted position;

FIG. 12 is a rear isometric view of the actuator assembly and the valve body of FIG. 11, but with a sealing member removed from between the perimeter compressor and the valve body;

FIG. 13 is a front isometric view depicting an actuator assembly and a valve body, in accordance with yet another embodiment;

FIG. 14 is a cross sectional view taken along the line 14-14 in FIG. 13;

FIG. 15 is a front isometric view depicting an actuator assembly and a valve body, in accordance with yet another embodiment;

FIG. 16 is a cross sectional view taken along the line 16-16 in FIG. 15;

FIG. 17 is a front isometric view depicting an actuator assembly and a valve body, in accordance with still yet another embodiment;

FIG. 18 is a cross sectional view taken along the line 18-18 in FIG. 17;

FIG. 19 is a front isometric view depicting an actuator assembly and a valve body, in accordance with still yet another embodiment;

FIG. 20 is a cross sectional view taken along the line 20-20 in FIG. 19,

FIG. 21 is a front isometric view depicting an actuator assembly and a valve body, in accordance with still yet another embodiment;

FIG. 22 is a cross sectional view taken along the line 22-22 in FIG. 21, with the actuator shaft and the perimeter compressor both shown in respective extended positions;

FIG. 23 is a cross sectional view of the actuator assembly and the valve body of FIG. 22, but with the actuator shaft shown in a retracted position,

FIG. 24 is a cross sectional view of the actuator assembly and the valve body of FIG. 23, but with the perimeter compressor shown in a retracted position;

FIG. 25 is a rear isometric view of the actuator assembly and the valve body of FIG. 24, but with a sealing member removed from between the perimeter compressor and the valve body;

FIG. 26 is a front isometric view depicting an actuator assembly and a valve body, in accordance with still yet another embodiment;

FIG. 27 is a cross sectional view taken along the line 27-27 in FIG. 26, with the actuator shaft and the perimeter compressor both shown in respective extended positions;

FIG. 28 is a cross sectional view of the actuator assembly and the valve body of FIG. 27, but with the actuator shaft shown in a retracted position;

FIG. 29 is a cross sectional view of the actuator assembly and the valve body of FIG. 28, but with the perimeter compressor shown in a retracted position;

FIG. 30 is a front isometric view depicting an actuator assembly and a valve body, in accordance with still yet another embodiment, and in association with a strip of sealing members shown in an initial position;

FIG. 31 is a cross sectional view taken along the line 31-31 in FIG. 30, with the actuator shaft and the perimeter compressor both shown in respective extended positions;

FIG. 32 is a cross sectional view of the actuator assembly, the valve body, and the strip of sealing members of FIG. 31, but with the actuator shaft shown in a retracted position;

FIG. 33 is a cross sectional view of the actuator assembly, the valve body, and the strip of sealing members of FIG. 32, but with the perimeter compressor shown in a retracted position;

FIG. 34 is a cross sectional view of the actuator assembly, the valve body, and the strip of sealing members of FIG. 33, but with the strip of sealing members shown in a partially advanced position;

FIG. 35 is a cross sectional view of the actuator assembly, the valve body, and the strip of sealing members of FIG. 34, but with the strip of sealing members shown in a fully advanced position;

FIG. 36 is an upper isometric view depicting an actuator assembly and a valve body, in accordance with still yet another embodiment, and in association with a conveyance system;

FIG. 37 is a lower isometric view depicting the actuator assembly, the valve body, and the conveyance system of FIG. 36;

FIG. 38 is a cross sectional view taken along the line 38-38 in FIG. 36, with an actuator shaft and a perimeter compressor both shown in respective extended positions and in association with a strip of sealing members shown in an initial position;

FIG. 39 is a cross sectional view of the actuator assembly, the valve body, and the conveyance system of FIG. 38, but with the actuator shaft and the perimeter compressor shown in a retracted position;

FIG. 40 is a cross sectional view of the actuator assembly, the valve body, the conveyance system, the actuator shaft and the perimeter compressor of FIG. 39, but with the strip of sealing members shown in a fully advanced position;

FIG. 41 is a cross sectional view of the actuator assembly, the valve body, the conveyance system, the actuator shaft and the perimeter compressor of FIG. 40, but with the perimeter compressor shown in the extended position;

FIG. 42 is an upper isometric view depicting an actuator assembly and a valve body, in accordance with still yet another embodiment, and in association with a continuous belt of sealing material;

FIG. 43 is a cross sectional view taken along the line 43-43 in FIG. 42, with a conveyance system shown and with an actuator shaft and a perimeter compressor both shown in respective extended positions;

FIG. 44 is a cross sectional view of the actuator assembly, the valve body, the continuous belt, and the conveyance system of FIG. 43, but with the actuator shaft shown in the retracted position;

FIG. 45 is a cross sectional view of the actuator assembly, the valve body, the continuous belt, and the conveyance system of FIG. 44, but with the actuator shaft and the perimeter compressor both shown in respective retracted positions;

FIG. 46 is an isometric view depicting a continuous belt of sealing material, in accordance with another embodiment;

FIG. 47 is an isometric view depicting a continuous belt of sealing material, in accordance with yet another embodiment;

FIG. 48 is an isometric view depicting a sealing member, in accordance with another embodiment;

FIG. 49 is an isometric view depicting a sealing member, in accordance with yet another embodiment; and

FIG. 50 is an isometric view depicting a sealing member, in accordance with still yet another embodiment.

### DETAILED DESCRIPTION

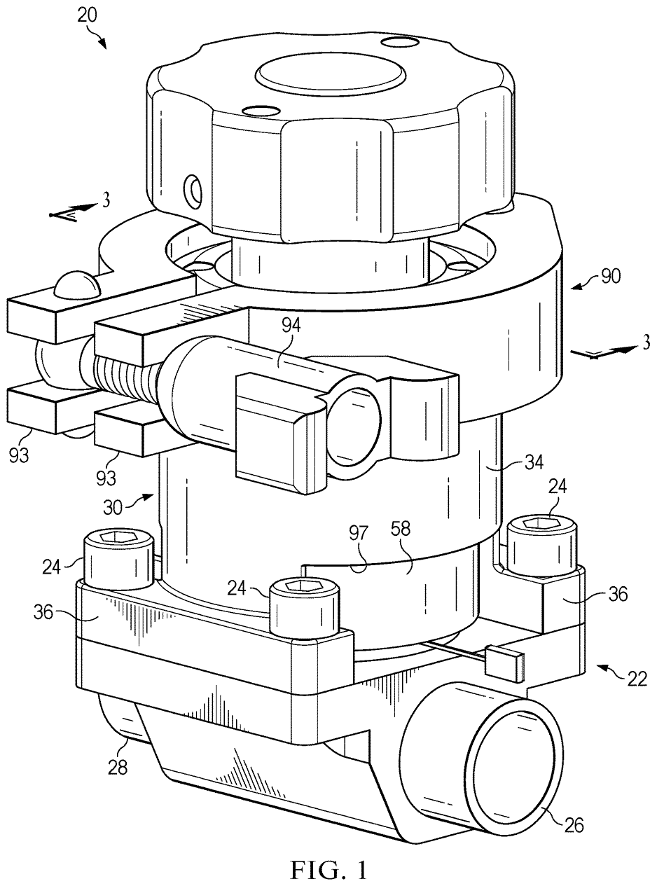

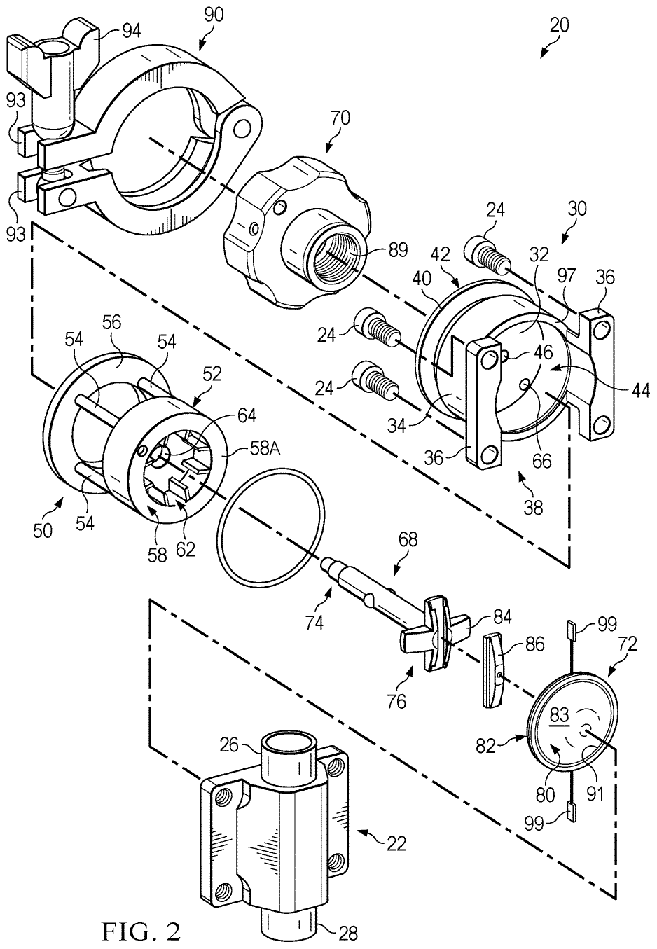

Embodiments are hereinafter described in detail in connection with the views and examples of FIGS. 1-50, wherein like numbers indicate the same or corresponding elements throughout the views. FIGS. 1-2 illustrate an actuator assembly 20 that is coupled with a valve body 22 by threaded fasteners 24 (collectively a valve actuator assembly). The valve body 22 can include a fluid inlet 26 and a fluid outlet 28 that enables fluid to flow through the valve body 22. The actuator assembly 20 can be associated with the valve body 22 to facilitate the control of fluid through the fluid inlet 26 and the fluid outlet 28. It is to be appreciated that the valve body can have any of a variety of suitable configurations such as different body shapes to conform to different diaphragm designs, as well as different inlet and outlet arrangements to conform to different process piping and tank application needs. Any of a variety of different body designs and shapes and/or valve body porting arrangements are contemplated and can be selected to conform to a particular application and/or industry. Accordingly, the present disclosure is intended to encompass these different configurations and should not be limited to the specific examples disclosed herein.

Referring now to FIG. 2, the actuator assembly 20 can include a main body 30 that includes an upper wall 32, a side wall 34, a lower flange 36 that can extend outwardly from the side wall 34 at a lower end 38 of the main body 30, and a base collar 40 that can extend outwardly from the side wall 34 at an upper end 42 of the main body 30. The threaded fasteners 24 can extend through the lower flange 36 and can be threaded into the valve body 22 to facilitate releasable attachment of the actuator assembly 20 to the valve body 22. It is to be appreciated that any of a variety of suitable alternative attachment arrangements for coupling the actuator assembly 20 to the valve body 22 are contemplated, such as, for example, through clamping, welding, or releasable fastening. The upper wall 32 and the side wall 34 can cooperate to define an interior receptacle 44 at the lower end 38 of the main body 30. The upper wall 32 can define an opening 46 that extends to the interior receptacle 44.

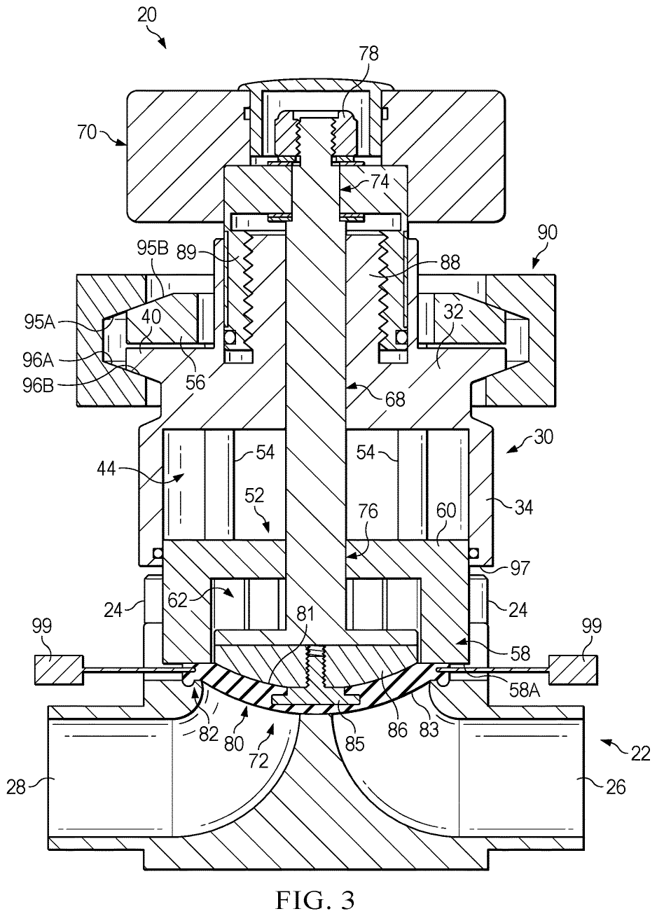

The actuator assembly 20 is shown to include a compressor assembly 50 that includes a perimeter compressor 52, a plurality of support members 54 and an external collar 56. The plurality of support members 54 can extend between the perimeter compressor 52 and the external collar 56 and can be coupled thereto with fasteners (e.g., screws), through welding, or with any of a variety of suitable attachment arrangements. The perimeter compressor 52 can include a side wall 58 and an upper wall 60 that cooperate with each other to define a receptacle 62. The side wall 58 can include a bottom surface 58A. The upper wall 60 can define an opening 64 that extends to the receptacle 62. As illustrated in FIG. 3, the perimeter compressor 52 can be disposed in the interior receptacle 44, the external collar 56 can be external to the interior receptacle 44 and disposed above the base collar 40, and the support members 54 can extend through openings 66 (one of which is shown in FIG. 2) in the upper wall 32 of the main body 30.

Referring now to FIGS. 2 and 3, the actuator assembly 20 can include an actuator shaft 68, a handle 70, and a sealing member 72. As illustrated in FIG. 2, the actuator shaft 68 can include a proximal end 74 and a distal end 76. As illustrated in FIG. 3, the actuator shaft 68 can extend through main body 30 (via the opening 46 shown in FIG. 2) and through the perimeter compressor 52 (via the opening 64 shown in FIG. 2) such that the proximal end 74 extends above the main body 30 and the distal end 76 can be at least partially disposed in the interior receptacle 44. The handle 70 can be operably coupled with the proximal end 74 via a nut 78 (FIG. 3). The sealing member 72 can include an inner portion 80 and an outer portion 82 that extends radially from the inner portion 80. The distal end 76 of the actuator shaft 68 can include a tip portion 84 that is releasably coupled with the inner portion 80 of the sealing member 72 at an upper surface 81 to facilitate replacement of the sealing member 72. In one embodiment, the inner portion 80 of the sealing member 72 can be slidably coupled with the tip portion 84 via a stud 85 and a rail 86. The stud 85 can be embedded in the inner portion 80 of the sealing member 72 and can be threadably coupled with, or otherwise coupled to, the rail 86. The rail 86 can be slidably coupled with the tip portion 84. In such an embodiment, when the sealing member 72 is installed on the tip portion 84, as illustrated in FIG. 3, and needs to be replaced, the sealing member 72 can be removed from the tip portion 84 by sliding the sealing member 72 in a direction that slides the rail 86 out of engagement with the tip portion 84. The new sealing member can then be installed by sliding its rail into engagement with the tip portion 84. The slidable engagement between the tip portion 84 and the rail 86 can effectively provide a quick release coupling that allows the sealing member 72 to be replaced more easily and more quickly than conventional arrangements that are threaded onto a tip portion of an actuator shaft. It is to be appreciated that although the rail 86 is shown to be an elongated member that spans or otherwise extends generally laterally along the inner portion 80, any of a variety of suitable alternative configurations for the rail 86 are contemplated. It is also to be appreciated, however, that even though the tip portion 84 and the rail 86 is described as having particular advantages over conventional arrangements, any of a variety releasable coupling arrangements are contemplated and may include these conventional arrangements to facilitate releasable coupling of the sealing member 72 to the tip portion 84.

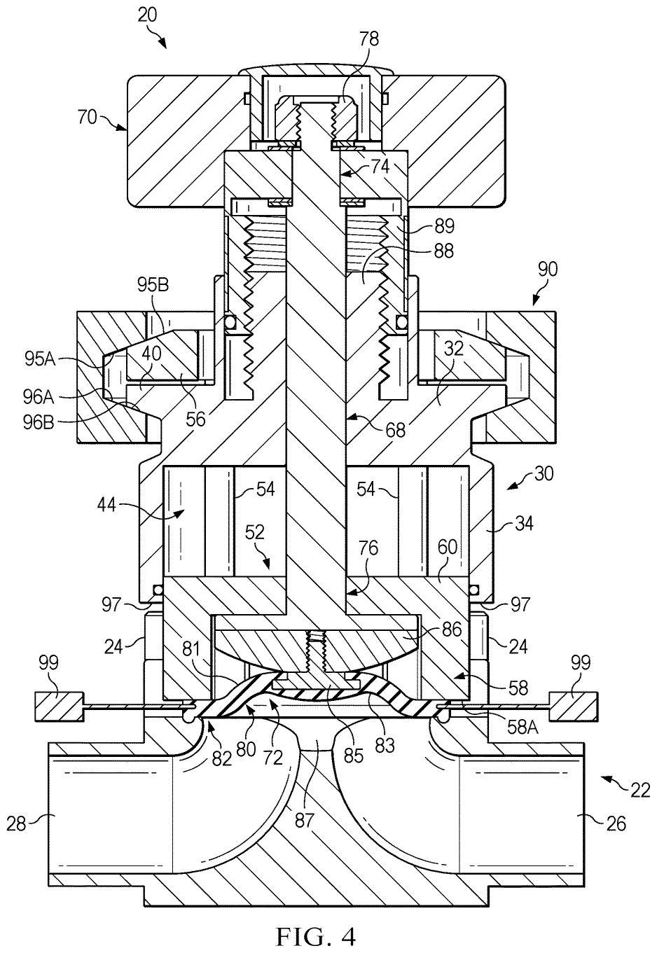

As illustrated in FIG. 3, the outer portion 82 of the sealing member 72 can extend between the valve body 22 and the side wall 58 of the perimeter compressor 52 and the inner portion 80 can extend therebetween (e.g., beneath the receptacle 62) such that the bottom surface 58A of the perimeter compressor 52 and the valve body 22 contact the upper surface 81 and a lower surface 83 (FIG. 3), respectively, of the sealing member 72. Although the outer portion 82 of the sealing member 72 is shown to only extend partially between the valve body 22 and the side wall 58, the outer portion 82 might also be flush with the side wall 58 or might extend beyond the side wall and thus still considered to be extending between the valve body 22 and the side wall 58. The sealing member 72 can be formed of an elastomeric material, such as rubber, non-elastomeric material, such as metal, or some combination thereof. In one embodiment, as illustrated in FIGS. 2 and 3, the sealing member 72 can comprise a round weir diaphragm. It is to be appreciated that although the sealing member 72 is illustrated as a round weir diaphragm, other types of sealing members are contemplated for use with the actuator assembly 20 in accordance with the principles described herein, and may have any of a variety of different shapes or configurations and may be formed of different materials to conform to the requirements of a particular valve type or industry application, such as, for example, an elliptical, rectangular or square weir diaphragm, a weirless diaphragm, and a radial diaphragm (including disc and pillar) and all other forms of diaphragms. Referring now to FIGS. 3 and 4, the actuator shaft 68 can be slidable with respect to the main body 30 between an extended position (FIG. 3) and a retracted position (FIG. 4). When the actuator shaft 68 is in the extended position, as illustrated in FIG. 3, the inner portion 80 of the sealing member 72 can be flexed toward the valve body 22 such that lower surface 83 of the sealing member 72 contacts a mating surface 87 that is disposed between the fluid inlet 26 and the fluid outlet 28 in order to provide an effective seal therebetween that prevents fluid from flowing between the fluid inlet 26 and the fluid outlet 28. When the actuator shaft 68 is in the retracted position, as illustrated in FIG. 4, the inner portion 80 of the sealing member 72 can be spaced from the valve body 22 to allow fluid to flow through the valve body 22 between the fluid inlet 26 and the fluid outlet 28 and past the sealing member 72.

The handle 70 can be threadably coupled with the main body 30. The main body 30 can include a threaded stem 88 that extends from the upper wall 32 and at least partially defines the opening 46 (FIG. 2). The handle 70 can include a threaded collar 89 that is threadably engaged with the threaded stem 88 such that rotation of the handle 70 facilitates sliding of the actuator shaft 68 between the extended position (FIG. 3) and the retracted position (FIG. 4). The actuator shaft 68 can be slid into the retracted position by rotating the handle 70 in an unthreading or loosening direction (e.g., in a counter-clockwise direction) and can be slid into the extended position by rotating the handle 70 in a threading or tightening direction (e.g., in a clockwise direction). It is to be appreciated that, although the handle 70 is shown to be operably coupled with the actuator shaft 68, any of a variety of suitable alternative actuators are contemplated that can be operably coupled with the proximal end 74 of the actuator shaft 68, to facilitate movement of the actuator shaft 68 between the extended and retracted positions, such as, for example, a pneumatic actuator or an electric actuator (e.g., a solenoid).

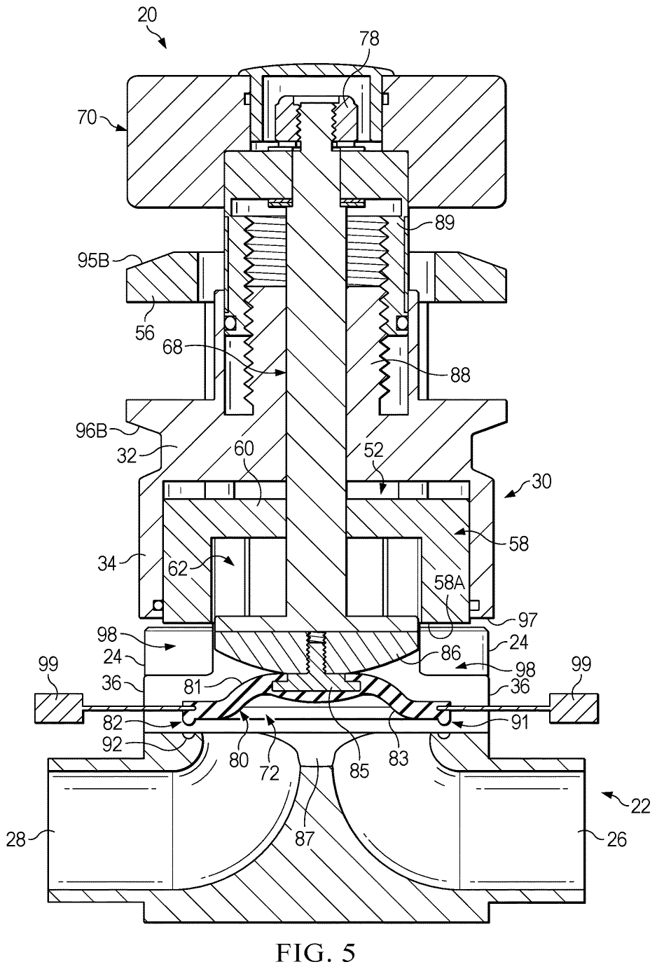

Referring now to FIGS. 4 and 5, the compressor assembly 50 can be slidable with respect to the main body 30 between an extended position (FIG. 4) and a retracted position (FIG. 5). As illustrated in FIG. 4, when the compressor assembly 50 is in the extended position, the compressor assembly 50 can engage the sealing member 72. As such, upper and lower surfaces 81, 83 can contact the bottom surface 58A of the side wall 58 and the valve body 22, respectively, at the outer portion 82 of the sealing member 72 such that the sealing member 72 is sandwiched (i.e., compressed) between the perimeter compressor 52 and the valve body 22. The external collar 56 can be proximate enough to the base collar 40 to allow a clamp 90 to secure the external collar 56 and the base collar 40 together. The clamp 90 can prevent the compressor assembly 50 from being inadvertently slid into the retracted position.

When the clamp 90 is installed over the external collar 56 and the base collar 40 and is tightened, the clamp 90 can facilitate sliding of the external collar 56 and the base collar 40 together such that the perimeter compressor 52 presses the outer portion 82 of the sealing member 72 and the valve body 22 together with enough force to effectively create a seal (i.e., a perimeter seal) therebetween. The sealing member 72 can include an annular rib 91 (FIG. 5) that interfaces with an annular groove 92 (FIG. 5) on the valve body 22 in an interfacing fit to releasably secure the valve body 22 and the outer portion 82 of the sealing member 72 together. It is to be appreciated, that the valve body 22 and the sealing member 72 can additionally or alternatively include other features that interface with each other to ensure proper alignment and coupling therebetween.

The clamp 90 can include a pair of arms 93 (FIG. 2) and a wingnut 94 (FIG. 2) that interfaces with the arms 93 to adjust the clamping force imparted by the clamp 90. When the wingnut 94 is tightened, and the arms 93 of the clamp 90 can be drawn together which can cause chamfered shoulders 95A, 96A (FIG. 4) of the clamp 90 to interface with chamfered shoulders 95B, 96B (FIG. 4), respectively, of the external collar 56 and the base collar 40 to urge the external collar 56 and the base collar 40 closer to each other. Because the base collar 40 is fixed together with the side wall 34, any sliding of the external collar 56 and the base collar 40 together can translate into sliding of the side wall 58 of the perimeter compressor 52 towards the sealing member 72 and the valve body 22. The downward force (i.e., sealing force) applied to the sealing member 72 can be a function of the clamping force applied by the clamp 90 and can be adjusted with the wingnut 94 of the perimeter compressor 52 towards the valve body 22 as a function of the clamping force of the clamp 90 such that simple adjustment of the wingnut 94 can facilitate control of the sealing force between the sealing member 72 and the valve body 22. The force imparted to the sealing member 72 can accordingly be adjusted more easily and more reliably than conventional actuator assembly arrangements where adjusting the force on a sealing member can be more difficult and time-consuming to accomplish and, if not done properly, can adversely affect the alignment of the sealing member. The clamp 90 can be selectively removed from the base collar 40 and the external collar 56, as illustrated in FIG. 5, which allows the compressor assembly 50 to slide or be otherwise moved into the retracted position.

Referring now to FIG. 5, at the moment the clamp 90 is removed and the base collar 40 and the external collar 56 are released, the downward force exerted by the compressor assembly 50 onto sealing member 72 (via the perimeter compressor 52) at upper surface 81 can be relieved. The compressor assembly 50 is no longer constrained by the clamp 90 and can be free to slide into the retracted position. Releasing of the compressor assembly 50 from the base collar 40 in this manner can relieve the downward force that is imparted by the perimeter compressor 52 onto the outer portion 82 of sealing member 72 (at the upper surface 81) which can release the perimeter seal between the sealing member 72 and the valve body 22, thus releasing the sealing member 72 from being captured between the valve body 22 around its perimeter and freeing it to be removed therefrom. The compressor assembly 50 can then be slid into the retracted position which disengages the perimeter compressor 52 from the sealing member 72. Once this occurs, the actuator shaft 68 can be slid into the retracted position, which can facilitate extraction of the sealing member 72 (which is still attached to actuator shaft 68 at its distal end 76) from the actuator assembly 20. The compressor assembly 50 is free to move independently of the actuator shaft 68. As such, when the actuator shaft 68 is slid to the retracted position, the corresponding upward movement of the sealing member 72 can cause the sealing member 72 to move towards the perimeter compressor 52 which can pull the compressor assembly 50 into its retracted position along with the actuator shaft 68. In one embodiment, the compressor assembly 50 and the actuator shaft 68 can be simultaneously moved into the retracted position by rotating the handle 70 in an unthreading or loosening direction (e.g., in a counter-clockwise direction). It is to be appreciated that the compressor assembly 50 and the actuator shaft 68 can be moved between their respective retracted and extended positions (either independently or simultaneously) with any of a variety of suitable alternative manual or automated arrangements.

Although the compressor assembly 50 and the actuator shaft 68 are described as being slidable relative to each other, alternative embodiments are contemplated where the compressor assembly 50 and the actuator shaft 68 are mechanically linked together during retraction of the compressor assembly 50 (i.e., in order to inspect or replace sealing member 72), such that the retraction of the actuator shaft 68 would automatically retract the compressor assembly 50 together with the actuator shaft 68. A new sealing member can then be installed on the tip portion 84 and the compressor assembly 50 and the actuator shaft 68 can be returned together to their respective extended positions. Once the compressor assembly 50 and the actuator shaft 68 reach their extended positions, the mechanical linkage between the compressor assembly 50 and the actuator shaft 68 can be released to release the compressor assembly 50 from the actuator shaft 68 to allow the compressor assembly 50 to engage with the sealing member 72 to reestablish the perimeter seal with the valve body 22. The actuator shaft 68 is accordingly returned to the regular operation to facilitate control of the flow through the valve body 22.

Referring again to FIGS. 4 and 5, the side wall 34 of the main body 30 can define a pair of access windows 97 that are disposed on opposite sides of the main body 30 adjacent to the valve body 22. When the compressor assembly 50 is in the extended position, the side wall 58 of the perimeter compressor 52 can extend over the access windows 97 to prevent access to the interior receptacle 44 through the access windows 97. As illustrated in FIG. 5, when the compressor assembly 50 is in the retracted position, the side wall 58 of the perimeter compressor 52 can be slid relative to the access windows 97 and can cooperate therewith to define respective openings 98 that extend into the interior receptacle 44. It is to be appreciated that although two rectangular shaped windows are illustrated, any quantity and shape of access windows are contemplated and can be located at any desired position along the side wall 34.

Sliding of the compressor assembly 50 and the actuator shaft 68 from the extended position (FIG. 4) to the retracted position (FIG. 5) can simultaneously reveal the openings 98, release the outer portion 82 from between the perimeter compressor 52 and the valve body 22, and position the sealing member 72 relative to the access windows 97 to enable the sealing member 72 to be inspected and/or replaced through the openings 98. For example, when the compressor assembly 50 and the actuator shaft 68 are slid into the retracted position, the perimeter compressor 52 and the inner portion 80 of the sealing member 72 can be pulled far enough away from the valve body 22 to allow the outer portion 82 of the sealing member 72 to be pulled out of engagement with the valve body 22 and properly inspected. The openings 98 can be simultaneously revealed and opened far enough to allow for such inspection through the openings 98 and also to allow for removal and replacement of the sealing member 72 from the interior receptacle 44 through the openings 98, if required. In one embodiment, the actuator shaft 68 can pull the inner portion 80 far enough away from the valve body 22 that the outer portion 82 automatically disengages from the valve body 22. In another embodiment, the actuator shaft 68 can only pull the inner portion 80 of the sealing member 72 away from the valve body 22 far enough that the outer portion 82 must still be manually dislodged from the valve body 22 (e.g., with the user's finger or a tool). In such an embodiment, the access windows 97 can be opened enough to allow enough room to permit the user to contact and dislodge the outer portion 82 from the valve body 22 through the openings 98.

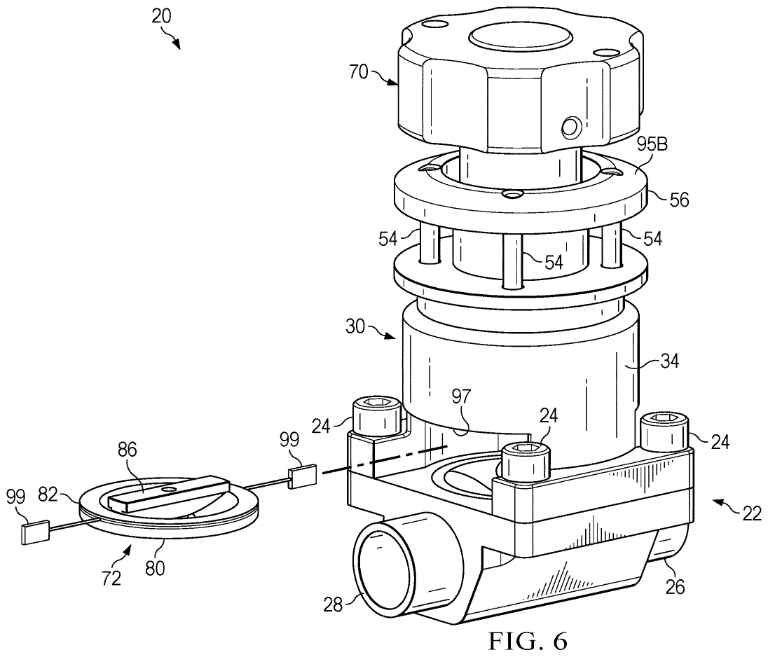

After inspection, if the sealing member 72 ultimately needs to be replaced, it can be disconnected from the tip portion 84 (by sliding in a direction that slides the rail 86 away from the tip portion 84) and pulled out of one of the openings 98, as illustrated in FIG. 6. In one embodiment, the sealing member 72 can include a tab portion 99 that extends outwardly from the outer portion 82 and can be grasped by a user to aid in the removal of the sealing member 72 from tip portion 84 and the interior receptacle 44. Once the sealing member 72 has been removed from the tip portion 84 and the interior receptacle 44, a new sealing member can then be inserted through either of the openings 98 and installed onto the tip portion 84 by sliding the new sealing member in a direction that slides its rail (e.g., 88) onto the tip portion 84. The compressor assembly 50 and the actuator shaft 68 can then be returned to their respective extended positions by rotating the handle 70 in a threading or tightening direction (e.g., in a clockwise direction).

As the compressor assembly 50 and the actuator shaft 68 return to their respective extended positions, the bottom surface 58A of the side wall 58 can contact the upper surface 81 of the sealing member 72 at the outer portion 82 which can urge the lower surface 83 of the sealing member 72 into contact with the valve body 22. The compressor assembly 50 can eventually force the annular rib 91 into the annular groove 92 on valve body 22 until a sealing engagement is created therebetween at which point the access windows 97 are closed to prevent access therethrough. The external collar 56 and the base collar 40 can then be secured together with the clamp 90 and the downward force on the new sealing member can be adjusted with the wingnut 94 to re-establish an effective perimeter seal therebetween.

It is to be appreciated that the actuator assembly 20 disclosed herein can allow for inspection and/or replacement of the sealing member 72 without requiring removal of the actuator assembly 20 from the valve body 22 as is typically the case with conventional arrangements. The ability to inspect and replace the sealing member 72 without removing the actuator assembly 20 from the valve body 22 can reduce the space, tools, labor, time and cost typically associated with conventional valve assemblies that typically require removal and re-installation of the actuator assembly to service a sealing member. In addition, since the actuator assembly 20 remains affixed to the valve body 22, the risk of injury due to mishandling of the actuator assembly during removal and installation is mitigated. The actuator assembly 20 can therefore provide a more reliable, cost effective, and less time consuming solution for replacing sealing members (e.g., diaphragms) than current conventional arrangements. Furthermore, by not requiring removal of the actuator assembly 20 to access the sealing member 72, the actuator assembly 20 can be permanently joined to or formed integrally with the valve body 22 (e.g., as a unitary one-piece design).

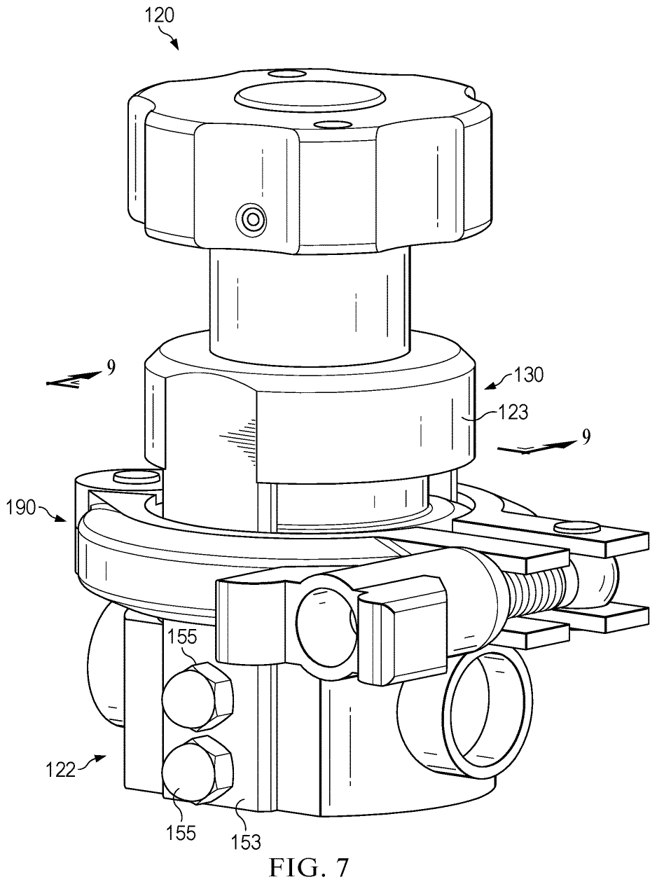

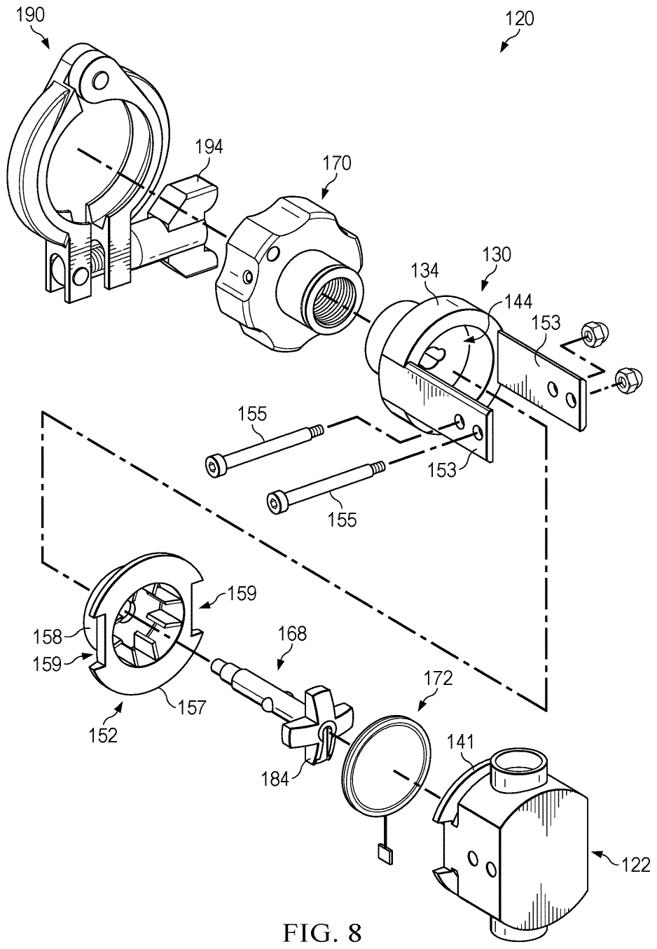

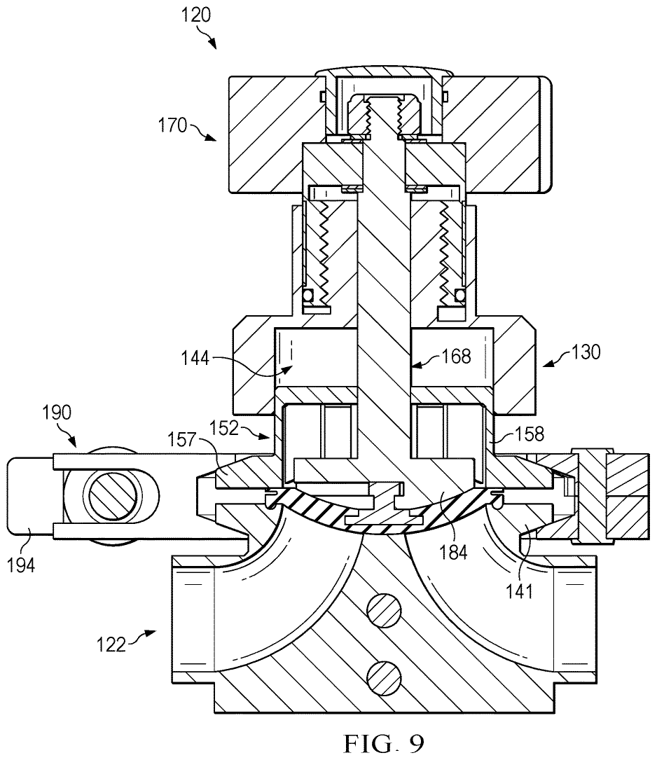

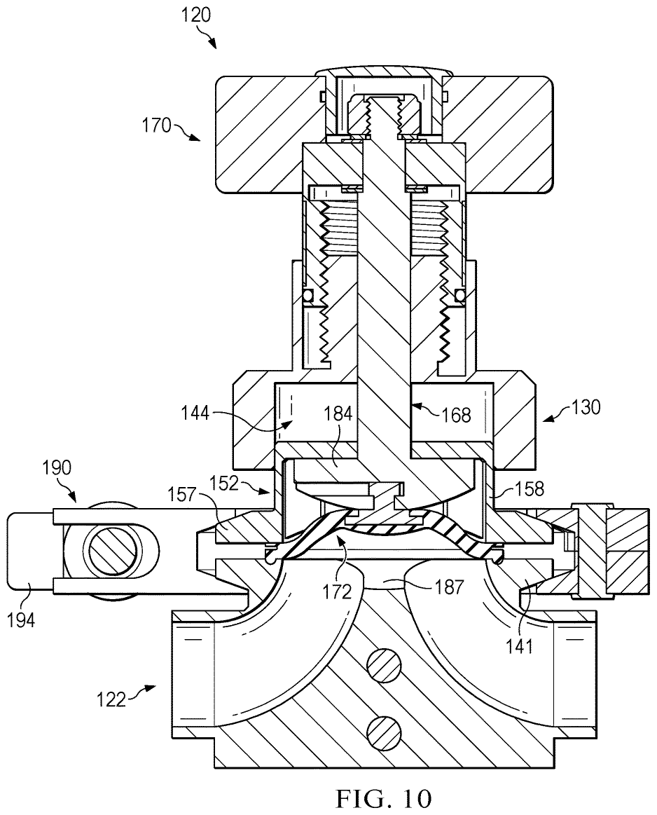

FIGS. 7-12 illustrate an alternative embodiment of an actuator assembly 120 that can be similar to, or the same in many respects as, the actuator assembly 20 illustrated in FIGS. 1-6. For example, as illustrated in FIGS. 7 and 8, the actuator assembly 120 can be associated with a valve body 122 and can include a main body 130, a perimeter compressor 152, a handle 170, and a clamp 190. The perimeter compressor 152 can include a side wall 158. As illustrated in FIGS. 8 and 9, the main body 130 can define an interior receptacle 144 and the perimeter compressor 152 can be at least partially disposed in the interior receptacle 144. An actuator shaft 168 can extend through each of the main body 130 and the perimeter compressor 152 and can be operably coupled with the handle 170. The actuator shaft 168 can include a tip portion 184 that is releasably coupled with sealing member 172. The actuator shaft 168 can be slidable between an extended position (FIG. 9) and a retracted position (FIG. 10) in response to rotation of the handle 170 to facilitate positioning of the sealing member 172 with respect to a mating surface 187 of the valve body 122. When the actuator shaft 168 is in the extended position, the sealing member 172 can contact the mating surface 187 to provide an effective seal therebetween that prevents fluid from flowing through the valve body 122. When the actuator shaft 168 is in the retracted position, the sealing member 172 can be spaced from the mating surface 187 to allow fluid to flow through the valve body 122.

The main body 130, however, can include a side wall 134 and a pair of support arms 153 that that extend from the side wall 134 and along the valve body 122 to facilitate coupling therebetween. The support arms 153 can support the actuator assembly 120 with respect to the valve body 122 so that the actuator assembly 120 remains attached to the valve body 122 when the clamp 190 is removed, as will be described in further detail below. In one embodiment, the support arms 153 can be releasably coupled to the valve body 122 with bolts 155.

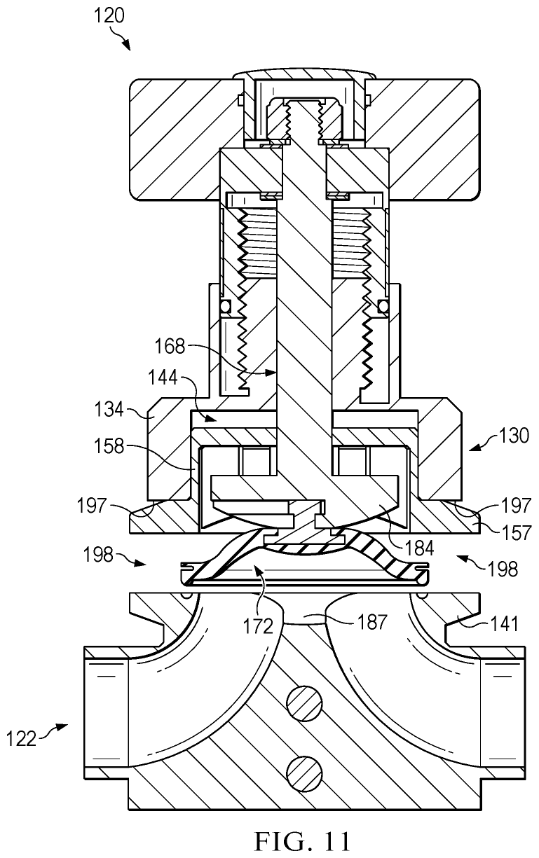

As illustrated in FIGS. 10 and 11, the perimeter compressor 152 can be slidable with respect to the main body 130 between an extended position (FIG. 10) and a retracted position (FIG. 11). As illustrated in FIG. 10, when the perimeter compressor 152 is in the extended position, the sealing member 172 can be sandwiched between the perimeter compressor 152 and the valve body 122 in a similar manner as described above with respect to the perimeter compressor 52 and the valve body 22.

The perimeter compressor 152, however, can include a compressor collar 157 that extends from the side wall 158 proximate to the valve body 122 and is rigidly fixed to the side wall 158. The compressor collar 157 can define a pair of notches 159 that accommodate the support arms 153. The valve body 122 can include a side wall 123 and a base collar 141 that that extends therefrom and is proximate to the compressor collar 157. The base collar 141 can be rigidly fixed to the side wall 123. When the perimeter compressor 152 is in the extended position, the base collar 141 can be proximate enough to the compressor collar 157 to allow the clamp 190 to secure the base collar 141 and the compressor collar 157 together. The clamp 190 can facilitate securement of the perimeter compressor 152 to the valve body 122 to prevent the perimeter compressor 152 from being inadvertently slid into the retracted position.

When the clamp 190 is installed over the base collar 141 and the compressor collar 157, the clamp 190 can be tightened to facilitate sliding of the base collar 141 and the compressor collar 157 together in a similar manner as described above with respect to the external collar 56 and the base collar 40. Since the base collar 141 is fixed to the side wall 123, the resultant sliding of the base collar 141 and the compressor collar 157 together can cause the side wall 158 of the perimeter compressor 152 to slide towards the sealing member 172 and the valve body 122. The downward force (i.e., sealing force) applied to the sealing member 172 can be a function of the clamping force applied by the clamp 190 and can be adjusted with a wingnut 194 in a similar manner as described above with respect to the clamp 190.

The clamp 190 can be removed from the base collar 141 and the compressor collar 157, as illustrated in FIG. 11. The removal of the clamp 190 from its engagement with base collar 151 and compressor collar 157 can release the perimeter compressor 152 from the valve body 122, which can, in turn, relieve the force the perimeter compressor 152 imparted to the sealing member 172 at the upper surface 181. The outer portion 182 can accordingly be disengaged from the valve body 122 such that the perimeter seal therebetween is no longer intact.

The removal of the clamp 190 in this embodiment can accordingly have a similar effect on the resulting components as the removal of the clamp 90 described above. However, the perimeter compressor 152 is not part of a compressor assembly (e.g., 50) and thus does not rely on other components (e.g., the plurality of support members 54 and the external collar 56) to facilitate sliding of the perimeter compressor 152 between the retracted and extended positions. The perimeter compressor 152 is however free to slide between its retracted and extended positions and can interact with the actuator shaft 168 and the sealing member 172 in a similar manner as described above with respect to the perimeter compressor 52, the actuator shaft 68, and the sealing member 72. For example, when the actuator shaft 168 is slid to the retracted position, the corresponding upward movement of the sealing member 172 can cause the sealing member 172 to contact the perimeter compressor 152 which can pull the perimeter compressor 152 into its retracted position along with the actuator shaft 168.

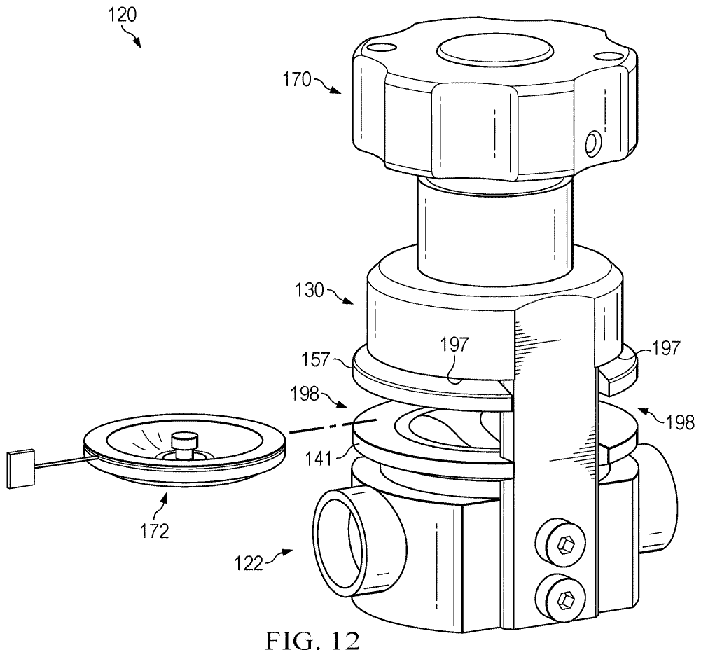

The side wall 134 and the support arms 153 can cooperate to define a pair of access windows 197 that are disposed on opposite sides of the main body 130 adjacent to the valve body 122. When the perimeter compressor 152 is in the extended position, the side wall 158 of the perimeter compressor 152 can overlie the access windows 197 to prevent access to the interior receptacle 144 through the access windows 197, as illustrated in FIGS. 9 and 10. As illustrated in FIG. 11, when the perimeter compressor 152 is in the retracted position, the side wall 158 has been slid back to allow access to the access windows 197 and can cooperate therewith to define respective openings 198 that extend into the interior receptacle 144 and enable the sealing member 172 to be inspected and/or replaced through the openings 198, as illustrated in FIG. 12 and in a similar manner as described above with respect to the openings 98. Once the inspection/installation of the sealing member 172 is complete, the perimeter compressor 152 can be returned to the extended position and the base collar 141 and the compressor collar 157 can be secured together with the clamp 190 to reestablish the perimeter seal.

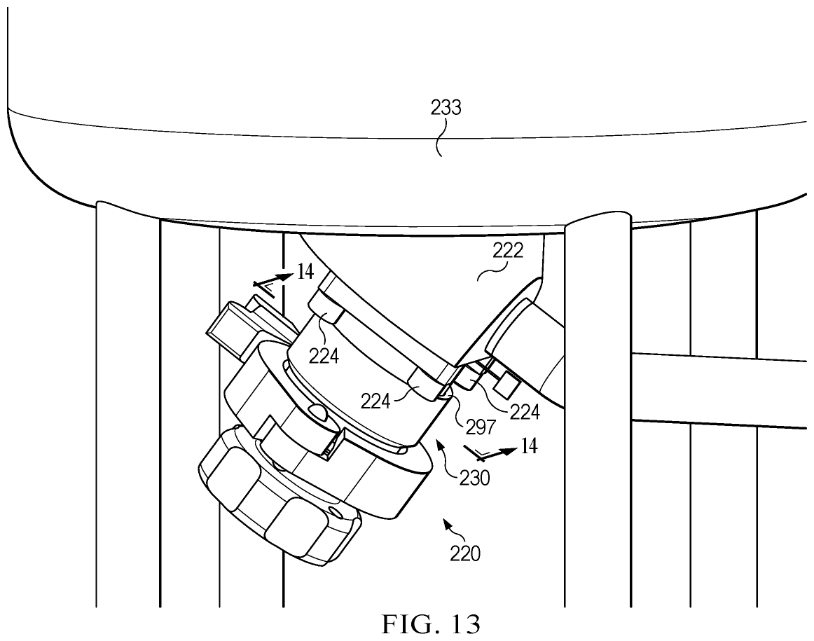

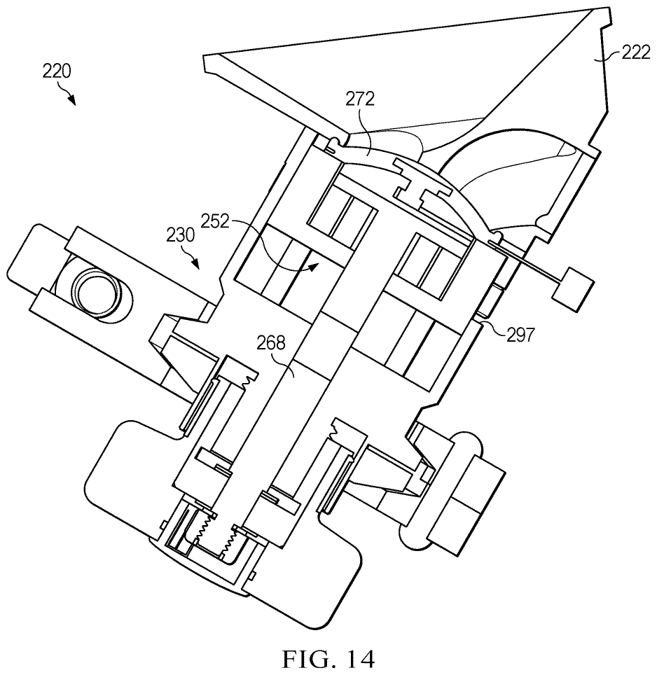

FIGS. 13 and 14 illustrate another alternative embodiment of an actuator assembly 220 that can be similar to, or the same in many respects as, the actuator assembly 20 illustrated in FIGS. 1-6. For example, the actuator assembly 220 can include a main body 230 and can be coupled to a valve body 222 with threaded fasteners 224. As illustrated in FIG. 14, the actuator assembly 220 can include an actuator shaft 268 and a sealing member 272 that is releasably coupled with the actuator shaft 268. The main body 230 can define an access window 297. A perimeter compressor 252 can be slidable with respect to the main body 230 between an extended position (FIG. 14) and a retracted position (not shown) to facilitate removal and replacement of the sealing member 272 through the access window 297. The valve body 222, however, can comprise a range of valve types and configurations, including a drain valve that is associated with a tank 233 (FIG. 13). The actuator shaft 268 can accordingly control the positioning the sealing member 272 relative to the valve body 222 to control the dispensation of fluid from the tank 233 through the valve body 222.

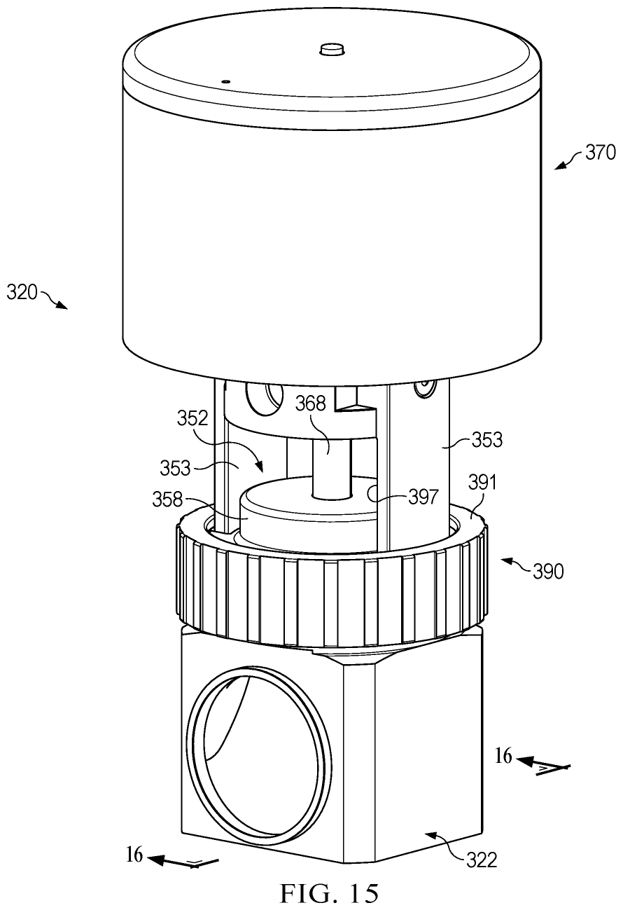

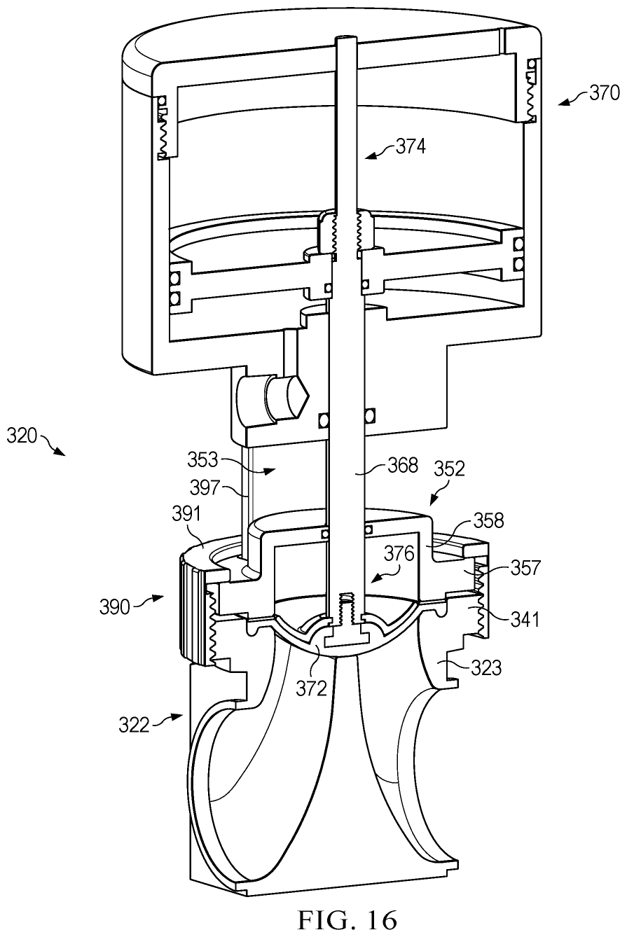

FIGS. 15 and 16 illustrate another alternative embodiment of an actuator assembly 320 that can be similar to, or the same in many respects as, the actuator assembly 120 illustrated in FIGS. 7-12. For example, the actuator assembly 320 can include an actuator shaft 368. As illustrated in FIG. 16, the actuator shaft 368 can include a proximal end 374 and a distal end 376. A sealing member 372 can be releasably coupled with the distal end 376 of the actuator shaft 368 to facilitate positioning of the sealing member 372 relative to the valve body 322 to control the flow of fluid therethrough.

The actuator assembly 320, however, can include a pneumatic actuator 370 that is operably coupled with the proximal end 374 of the actuator shaft 368 and facilitates pneumatic control of the actuator shaft 368 between its extended and retracted positions. The actuator assembly 320 can include a pair of support arms 353 that extend between, and are coupled to, the valve body 322 and the pneumatic actuator 370. The pneumatic actuator 370 can cooperate with the support arms 353 to define a pair of access windows 397.

A perimeter compressor 352 can be slidable with respect to the valve body 322 and the pneumatic actuator 370 between an extended position (FIG. 16) and a retracted position (not shown) to facilitate removal and replacement of the sealing member 372 through the access windows 397. As illustrated in FIG. 16, the perimeter compressor 352 can include a side wall 358 and a compressor collar 357 that extends from the side wall 358 proximate to the valve body 322. The valve body 322 can include a side wall 323 and a base collar 341 that that extends therefrom. As illustrated in FIG. 16, when the perimeter compressor 352 is in the extended position, the base collar 341 and the compressor collar 357 can be releasably secured together with a clamp ring 390 that is threadedly engaged with the base collar 341. The clamp ring 390 can include an annular ring portion 391 that engages the compressor collar 357 such that when the clamp ring 390 is tightened, the base collar 341 and the compressor collar 357 are urged towards each other. When the perimeter compressor 352 is to be moved into the extended position, the clamp ring 390 can be unthreaded from the base collar 341 to release the compressor collar 357 from the base collar 341. It is to be appreciated that, although the clamp 90 and the clamp ring 390 are illustrated herein, any of a variety of suitable alternative securement arrangements are contemplated for securing a perimeter compressor in its extended position.

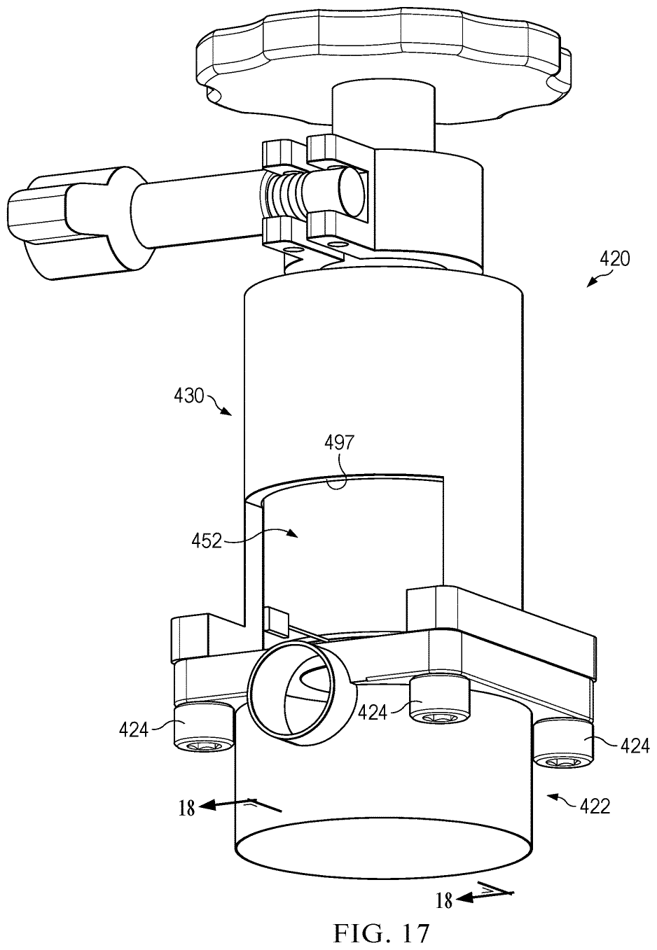

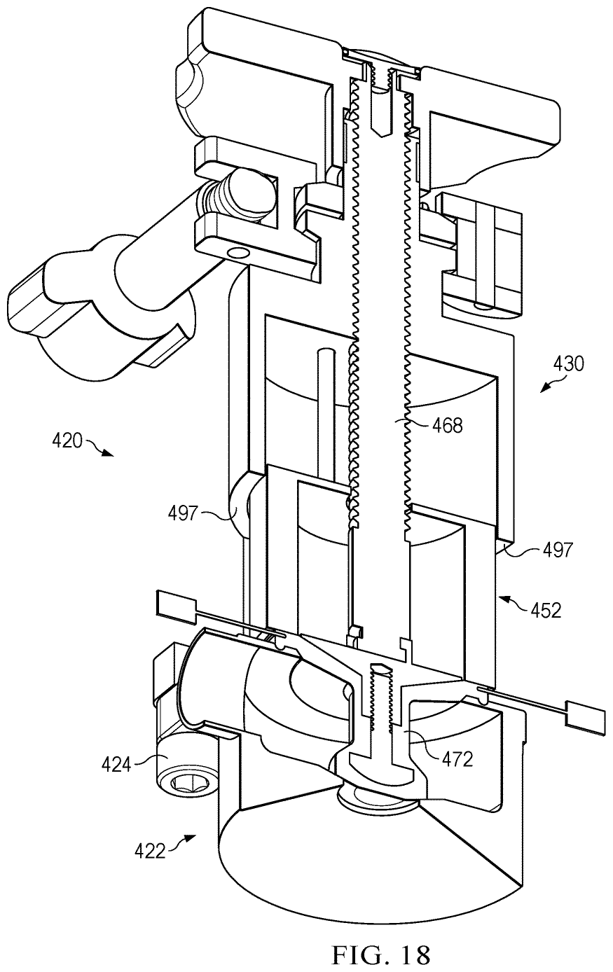

FIGS. 17 and 18 illustrate yet another alternative embodiment of an actuator assembly 420 that can be similar to, or the same in many respects as, the actuator assembly 20 illustrated in FIGS. 1-6. For example, the actuator assembly 420 can include a main body 430 and can be coupled to a valve body 422 with threaded fasteners 424. As illustrated in FIG. 18, the actuator assembly 420 can include an actuator shaft 468 and a sealing member 472 that is releasably coupled with the actuator shaft 468. The main body 430 can define a pair of access windows 497. A perimeter compressor 452 can be slidable with respect to the main body 430 between an extended position (FIG. 18) and a retracted position (not shown) to facilitate removal and replacement of the sealing member 472 through the access windows 497. The sealing member 472, however, can comprise a radial diaphragm valve that is taller than the sealing members (e.g., 72, 172, 272, 372) disclosed above. As such, the pair of access windows 497 can be sized to provide a larger vertical opening as compared to the access windows (e.g., 97, 197, 297, 397), in order to accommodate for the taller profile.

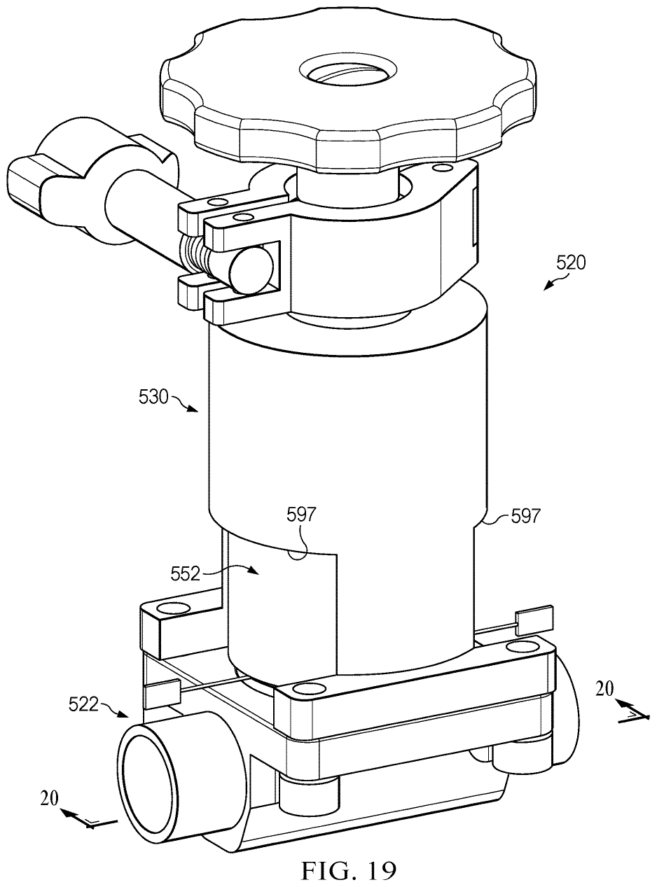

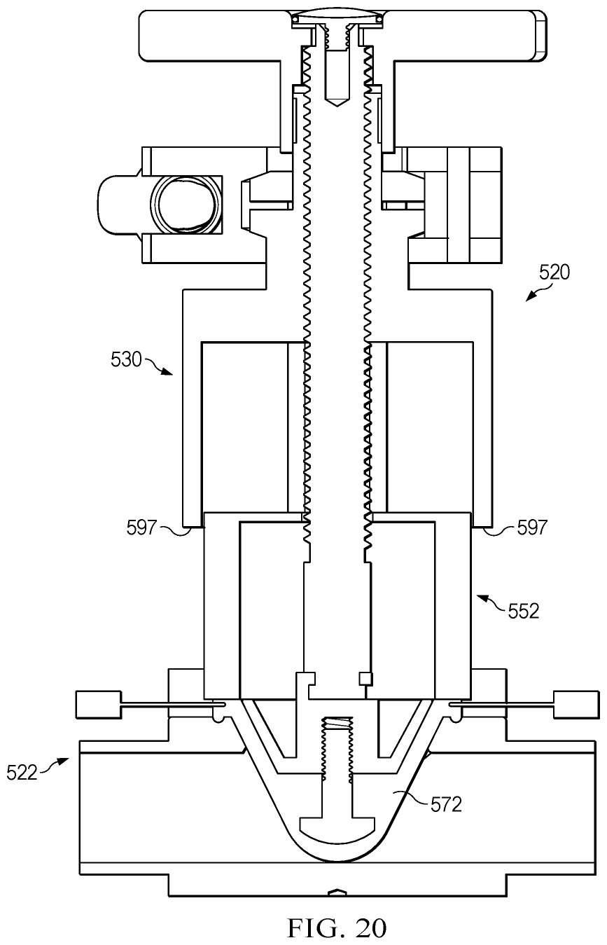

FIGS. 19 and 20 illustrate yet another alternative embodiment of an actuator assembly 520 that can be similar to, or the same in many respects as, the actuator assembly 420 illustrated in FIGS. 17 and 18. For example, the actuator assembly 520 can include a main body 530 and can be coupled to a valve body 522. As illustrated in FIG. 18, the main body 530 can define a pair of access windows 597. A perimeter compressor 552 can be slidable with respect to the main body 530 between an extended position (FIG. 20) and a retracted position (not shown) to facilitate removal and replacement of the sealing member 572 through the access windows 597. The sealing member 572, however, can comprise a weirless diaphragm, that has a different profile than the sealing member 472 illustrated in FIGS. 17 and 18.

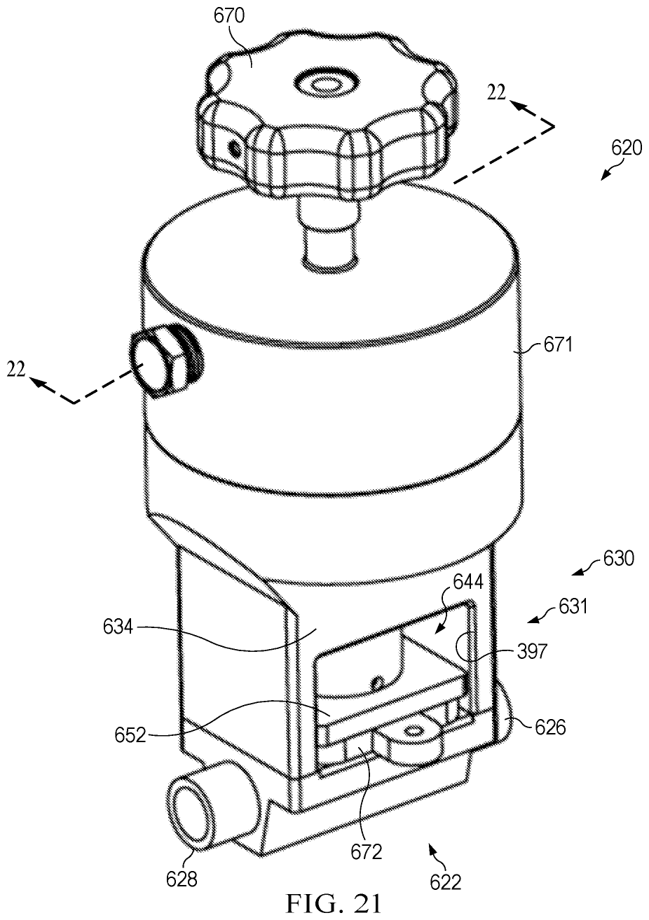

FIGS. 21-25 illustrate an alternative embodiment of an actuator assembly 620 that can be similar to, or the same in many respects as, the actuator assemblies 20, 120, 220, 320, 420, 520 illustrated in FIGS. 1-20. For example, as illustrated in FIG. 21, the actuator assembly 620 can be associated with a valve body 622 and can include a main body 630, a perimeter compressor 652, and a handle 670. The valve body 622 can be rigidly attached to the main body 630 through welding or other permanent coupling arrangement. In some embodiments, the valve body and the main body 630 can be formed together as a unitary one piece construction (e.g., machined from the same monolithic structure, or formed from additive manufacturing, or molded together via a molding process). The perimeter compressor 652 can cooperate with the valve body 622 to facilitate selective compression of a sealing member 672 therebetween. The main body 630, however, can include a base 631 that includes a pair of sidewalls 634 (one shown) that each defines a window 697 (one shown) that allows for access to the sealing member 672 in order to allow the sealing member 672 to be removed and replaced with a new sealing member. The base 631 can define an interior receptacle 644 and the perimeter compressor 652 can be at least partially disposed in the interior receptacle 644 such that the perimeter compressor 652 overlies the sealing member 672. The main body 630 can further include a piston housing 671 that is coupled with the base 631.

As illustrated in FIG. 21, the piston housing 671 can be coupled with the base 631 and can cooperate with the base 631 to define a piston chamber 673. The piston housing 671 is shown to be threadedly coupled with the base 631 and with a seal (e.g., an O-ring) provided therebetween for sealing the threaded interface. It is to be appreciated that that the piston housing 671 can be removably coupled to the base 631 using any of a variety of suitable alternative attachment arrangements, such as a bayonet connection, and in some instances might be permanently attached to the base 631, such as through welding, for example. An actuator shaft 668 can extend through each of the base 631 and the piston housing 671 and can be coupled at a proximal end 674 to the handle 670 and at a distal end 676 to the sealing member 672. The handle 670 can be threadedly engaged with the distal end 676 of the actuator shaft 668 and with the piston housing 671 such that actuation of the handle 670 slides the actuator shaft 668 to actuate the sealing member 672.

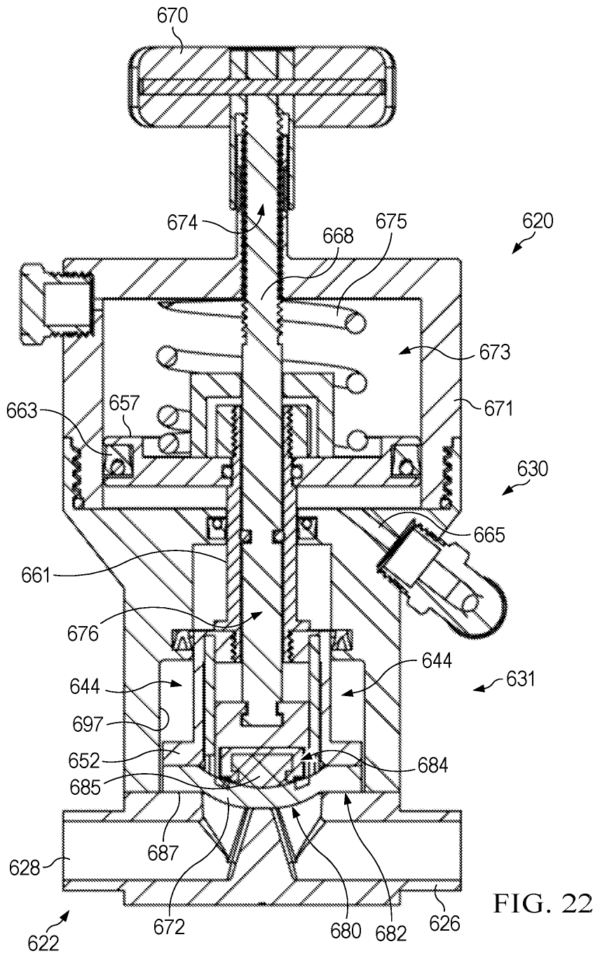

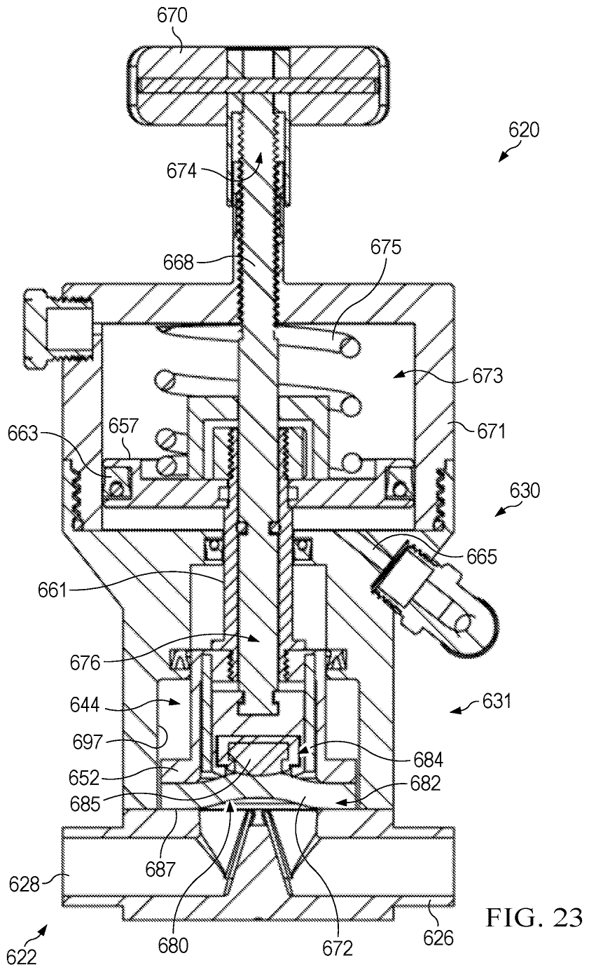

As illustrated in FIGS. 22 and 23, rotation of the handle 670 in different directions (e.g., clockwise and a counterclockwise) can facilitate sliding of the actuator shaft 668 into an extended position (FIG. 22) and a retracted position (FIG. 23). The actuator shaft 668 can include a tip portion 684 that is releasably coupled with the sealing member 672. When the actuator shaft 668 is slid into the extended position, as illustrated in FIG. 22, the actuator shaft 668 can urge the sealing member 672 into a sealed position such that an inner portion 680 of sealing member 672 contacts a mating surface 687 of the valve body 622 to provide an effective seal therebetween that prevents fluid from flowing through the fluid inlet 626 and the fluid outlet 628. When the actuator shaft 668 is in the retracted position, as illustrated in FIG. 23, the actuator shaft 668 can pull the sealing member 672 into an opened position such that the inner portion 680 is pulled away from the mating surface 687 to allow fluid to flow through between the fluid inlet 626 and the fluid outlet 628.

A pneumatic actuator in the form of a piston 657 can be operably coupled with the perimeter compressor 652 to facilitate actuation of the perimeter compressor 652 by the piston 657. The piston 657 can be disposed in a piston chamber 673 defined by the piston housing 671. The piston 657 can be coupled to a valve sleeve 661 which is in turn coupled with the perimeter compressor 652. In one embodiment, the piston 657 and the perimeter compressor 652 can be threadedly coupled with the valve sleeve 661 but any suitable coupling arrangement is contemplated. The valve sleeve 661 can be a hollow sleeve that surrounds the actuator shaft 668 and thus allows the actuator shaft 668 to pass through the piston 657 and the valve sleeve 661 and to the sealing member 672. The actuator shaft 668 can be slidable relative to the valve sleeve 661, and the valve sleeve 661 can be slidable relative to actuator shaft 668 such that the actuator shaft 668 and the valve sleeve 661 are slidable relative to each other and independently of one another as will be appreciated from the additional details provided below.

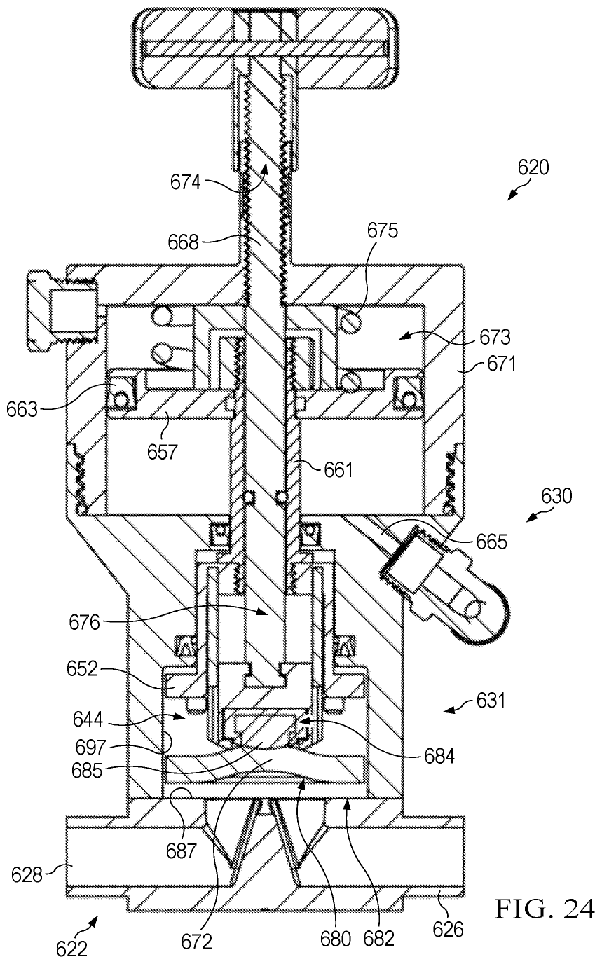

As illustrated in FIGS. 23 and 24, the piston 657, the valve sleeve 661, and the perimeter compressor 652 can be slidable together between an extended position (FIG. 23) and a retracted position (FIG. 24). A piston ring 663 can be interposed between the piston 657 and the piston housing 671 to allow for sliding of the piston 657 between the extended and retracted positions. When the piston 657, the valve sleeve 661, and the perimeter compressor 652 are in the extended position, as illustrated in FIG. 23, the perimeter compressor 652 can compress an outer portion 682 of the sealing member 672 between the valve body 622 and the perimeter compressor 652 with enough force (i.e., in the direction of the valve body 622) to create an effective seal therebetween. A spring 675 (e.g., a biasing member) can be provided between the piston 657 and the piston housing 671 and can be configured to bias the piston 657 into the extended position. The spring 675 can accordingly be responsible for the force that is applied by the perimeter compressor 652 onto the outer portion 682 of the sealing member 672. The configuration of the spring 675 can therefore be selected to apply any desired amount of force onto the outer portion 682 of the sealing of the sealing member 672. Because the sealing member 672 is formed of a pliable material, the outer portion 682 of the sealing member 672 may deform over time and which can cause the outer portion 682 to be thinner at the interface between the valve body 622 and the perimeter compressor 652. However, even when this deformation/thinning occurs, the spring 675 can maintain enough force on the perimeter compressor 652 to ensure that the outer portion 682 of the sealing member 672 still maintains a proper seal at the interface between the valve body 622 and the perimeter compressor 652.

When the piston 657, the valve sleeve 661, and the perimeter compressor 652 are slid to the retracted position, as illustrated in FIG. 24, the perimeter compressor 652 can be pulled away from the outer portion 682 of the sealing member 672 far enough to allow the sealing member 672 to be replaced through one of the windows 697. As such, when the piston 657, the valve sleeve 661, and the perimeter compressor 652 are slid to the retracted position, that actuator assembly 620 can be considered to be in a maintenance mode that allows for maintenance to be performed on the sealing member 672.

The piston 657 can be pneumatically actuated to facilitate sliding of the perimeter compressor 652 between the extended position and the retracted position. The piston housing 671 can define a fluid port 665 that is in fluid communication with the piston chamber 673 to allow for fluid (e.g., air) to be selectively introduced into the piston chamber 673 to pressurize the volume between the piston 657 to thereby actuate the piston 657. For example, before fluid is provided through the fluid port 665, the piston 657 can be biased into the extended position by the spring 675. When air is introduced through the fluid port 665 and the pressure of the fluid overcomes the biasing force of the spring 675, the pressure of the fluid can slide the piston 657 into the retracted piston which correspondingly slides the perimeter compressor 652 into the retracted position. The pressure can be maintained on the piston 657 to allow for maintenance of the sealing member 672. Once the maintenance on the sealing member 672 has been completed (e.g., the sealing member 672 has been successfully replaced), the pressure can be released from the piston 657 and the piston 657 can be returned to the extended position by the spring 675.

The fluid port 665 can be coupled with a pneumatic system (not shown) that allows for automated control of the piston 657 and thus partially automated maintenance of the sealing member 672. For example, when maintenance is to be performed on the sealing member 672, the pneumatic system can automatically slide the piston 657 and the perimeter compressor 652 into the retracted position thus freeing the sealing member 672. A user can then rotate the handle 670 to retract the sealing member 672 far enough that the sealing member 672 can be removed from the tip portion 684. Once the sealing member 672 has been successfully replaced, the user can rotate the handle 670 to extend the actuator shaft 668 and position the new sealing member against the valve body 622. Once the new sealing member is positioned properly, the pneumatic system can remove the pressure from the piston 657 to allow for the perimeter compressor 652 to return to the extended position and compress the new sealing member. In one embodiment, the sealing member 672 can be replaced manually by the user. In another embodiment, the sealing member 672 can be automatically replaced by an automated system which allows for automatic replacement of the sealing member 672 as will be described in further detail below. It is to be appreciated that although a piston is described, any of a variety of suitable alternative pneumatic actuators or electric actuators (e.g., a solenoid) are contemplated for automatically actuating the perimeter compressor 652 to allow for maintenance of the sealing member 672.

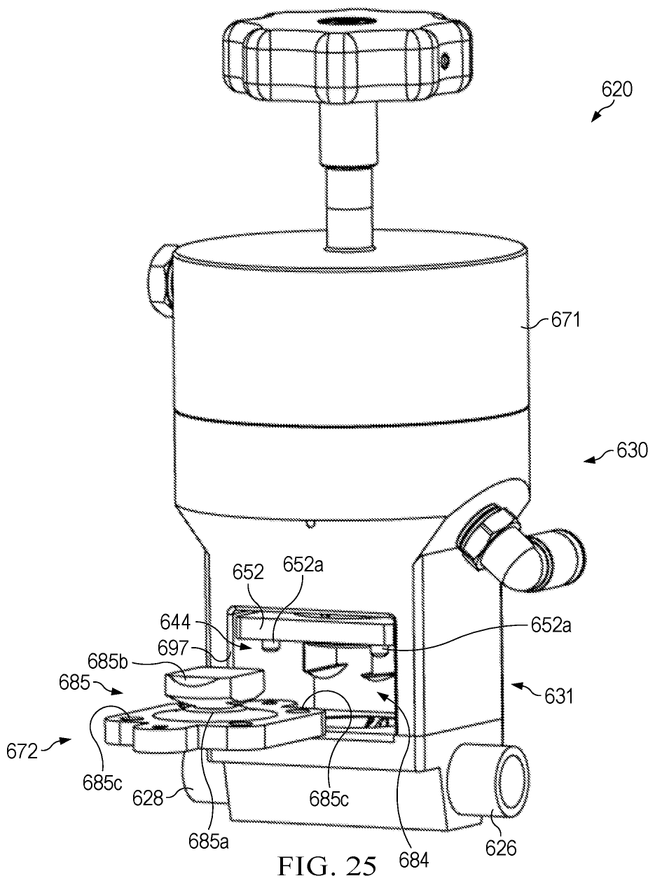

Referring now to FIG. 25, the sealing member 672 is shown to be removed from the actuator assembly 620 with the actuator shaft 668 and the perimeter compressor 652 shown in their respective retracted positions. The sealing member 672 can include a stud 685 (e.g., a key) that facilitates attachment of the sealing member 672 to the tip portion 684. The stud 685 can include a tapered base 685a and a chamfered upper surface 685b. The tip portion 684 can include a pair of supports 684a that are spaced from each other and define a keyway. When the sealing member 672 is initially installed on the tip portion 684, the stud 685 can be slid between the supports 684a and into the keyway such that the supports 684a extend towards the tapered base 685a and effectively cradle the stud 685. As the perimeter compressor 652 is then slid into the extended position, if the sealing member 672 is slightly misaligned, the perimeter compressor 652 can contact the chamfered upper surface 685b to urge the stud 685, and thus the sealing member 672, into alignment beneath the perimeter compressor 652 before the perimeter compressor 652 is fully provided into the extended position.

The perimeter compressor 652 can include a plurality of engagement pins 652a that extend toward the sealing member 672a and the valve body 622. The engagement pins 652 can correspond with through holes 685c provided in the sealing member 672a. When the perimeter compressor 652 is provided in the extended position, the engagement pins 652a can extend into the through holes 685c to encourage proper alignment of the sealing member 672a relative to the perimeter compressor 652. The engagement pins 652a can also contact the valve body 622 to prevent further compression of the sealing member 672a. The height of the plurality of engagement pins 652a can therefore be selected to prevent over compression of the sealing member 672a. It is to be appreciated that although the actuator assembly 620 is shown associated with the valve body 622, the actuator assembly 620 can be a stand-alone device that can be incorporated onto any type of valve body, which includes, but is not limited to, a valve body incorporated onto a storage vessel (i.e., a tank) or a valve body that is integral with a plantwide fluid distribution system.

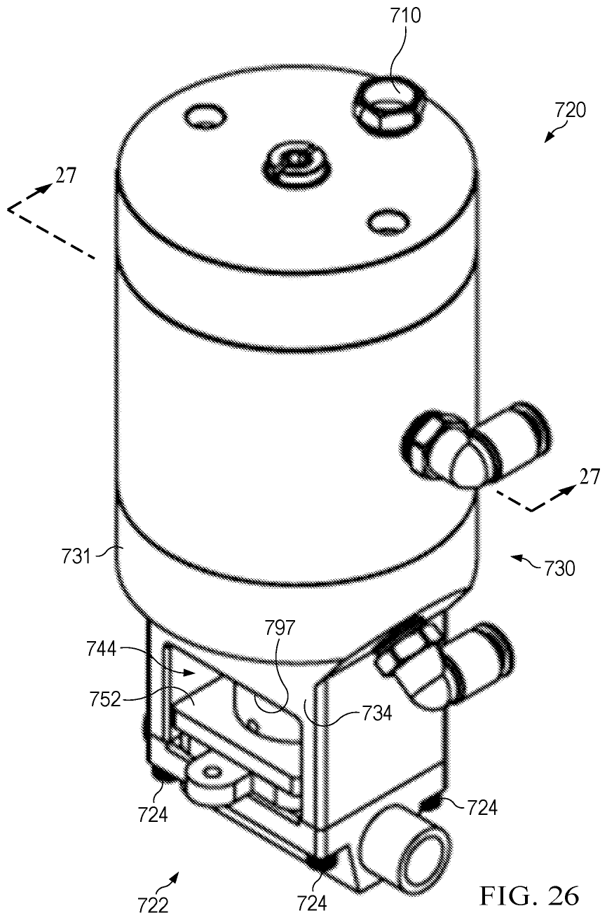

FIGS. 26-29 illustrate yet another alternative embodiment of an actuator assembly 720 that can be similar to, or the same in many respects as, the actuator assemblies 20, 120, 220, 320, 420, 520, 620 illustrated in FIGS. 1-25. For example, as illustrated in FIG. 26, the actuator assembly 720 can be associated with a valve body 722 and can include a main body 730, and a perimeter compressor 752. The valve body 722 can be releasably attached to the main body 730 via fasteners 724 but can alternatively be permanently coupled thereto. The perimeter compressor 752 can cooperate with the valve body 722 to facilitate selective compression of a sealing member 772 therebetween. The main body 730, however, can include a base 731 that includes a pair of sidewalls 734 (one shown) that each defines a window 797 (one shown) that allows for access to the sealing member 772 in order to allow the sealing member 772 to be removed and replaced with a new sealing member. The base 731 can define an interior receptacle 744 and the perimeter compressor 752 can be at least partially disposed in the interior receptacle 744 such that the perimeter compressor 752 overlies the sealing member 772. The main body 730 can further include a piston housing 771 that is coupled with the base 731.

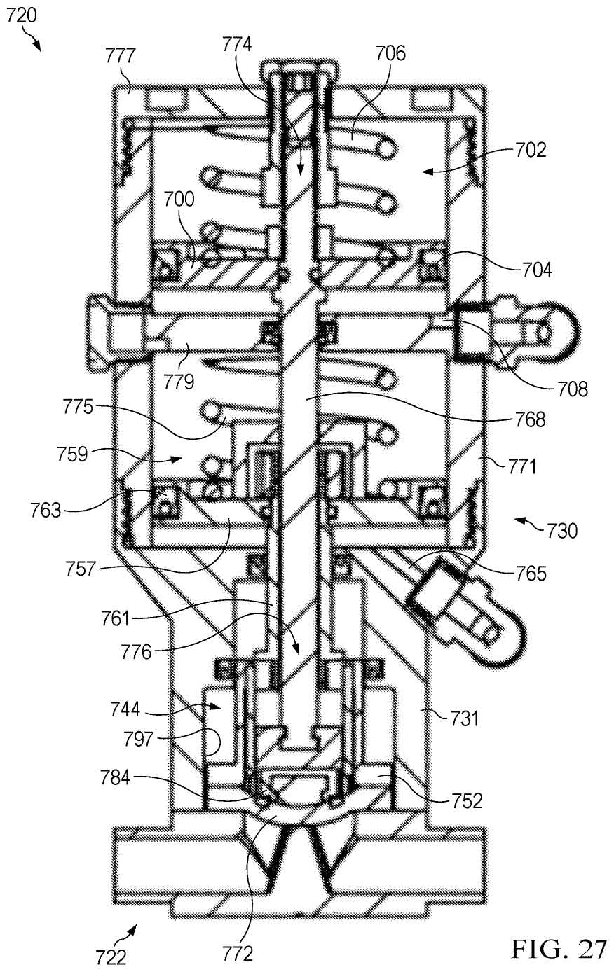

As illustrated in FIG. 27, the piston housing 771 can be coupled with the base 731 and can include a cap 777 and a partition 779. The piston housing 771 is shown to be threadedly coupled with the base 731 and with a seal (e.g., an O-ring) provided therebetween for sealing the threaded interface. An actuator shaft 768 can extend through each of the base 731 and the piston housing 771 and can be coupled at a distal end 776 to the sealing member 772. However, a pneumatic actuator in the form of an upper piston 700 can be operably coupled with a proximal end 774 of the actuator shaft 768 to facilitate actuation of the sealing member 772 by the upper piston 700. The upper piston 700 can be disposed in an upper piston chamber 702 defined by the piston housing 771, the cap 777, and the partition 779.

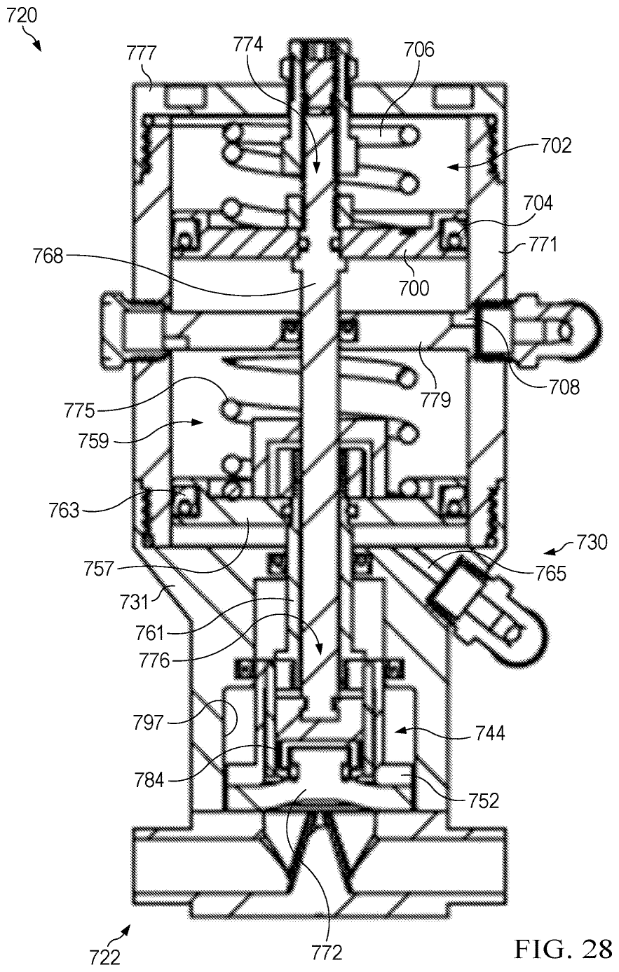

As illustrated in FIGS. 27 and 28, the upper piston 700 and the actuator shaft 768 can be slidable together between an extended position (FIG. 27) and a retracted position (FIG. 28). A piston ring 704 can be interposed between the upper piston 700 and the piston housing 771 to allow for sliding of the upper piston 700 with respect to the piston housing 771 between the extended and retracted positions. A spring 706 can be provided between the upper piston 700 and the cap 777 and can be configured to bias the upper piston 700 into the extended position. The actuator shaft 768 can include a tip portion 784 that is releasably coupled with the sealing member 772. When the upper piston 700 and actuator shaft 768 are in the extended position, as illustrated in FIG. 27, the actuator shaft 768 can urge the sealing member 772 into a closed (i.e., sealed) position. When the upper piston 700 and the actuator shaft 768 are in the retracted position, as illustrated in FIG. 28, the actuator shaft 768 can pull the sealing member 772 into an opened position.

The upper piston 700 can be pneumatically actuated to facilitate sliding of the actuator shaft 768 between the extended position and the retracted position. The piston housing 771 can define a fluid port 708 that is in fluid communication with the upper piston chamber 702 to allow for fluid (e.g., air) to be selectively introduced into upper piston chamber 702 to pressurize the volume between the upper piston 700 and the partition 779 to thereby actuate the upper piston 700. For example, before fluid is provided through the fluid port 708, the upper piston 700 can be biased into the extended position by the spring 706. When air is introduced through the fluid port 708 and the pressure of the fluid overcomes the biasing force of the spring 706, the upper piston 700 can slide into the retracted piston which correspondingly slides the sealing member 772 into the opened position. To close the sealing member 772, the pressure can be released from the upper piston chamber 702 and the upper piston 700 can be returned to the extended position by the spring 706. The cap 777 can include a vent port 710 (FIG. 26) that allows the volume between the upper piston 700 and the cap 777 to effectively breathe during sliding of the upper piston 700.

A lower piston 757 can be operably coupled with the perimeter compressor 752 to facilitate pneumatic actuation of the perimeter compressor 752 by the lower piston 757. The lower piston 757 can be disposed in a lower piston chamber 773 that is defined by the base 731, the piston housing 771, and the partition 779 such that the partition separates the upper piston chamber 702 from the lower piston chamber 773. The lower piston 757 can be coupled to a valve sleeve 761 which is in turn coupled with the perimeter compressor 752. The valve sleeve 761 can be a hollow sleeve that surrounds the actuator shaft 768 and thus allows the actuator shaft 768 to pass through the lower piston 757 and the valve sleeve 761 and to the sealing member 772. The actuator shaft 768 can be slidable relative to the valve sleeve 761, and the valve sleeve 761 can be slidable relative to actuator shaft 768 such that the actuator shaft 768 and the valve sleeve 761 are slidable relative to each other and independently of one another.

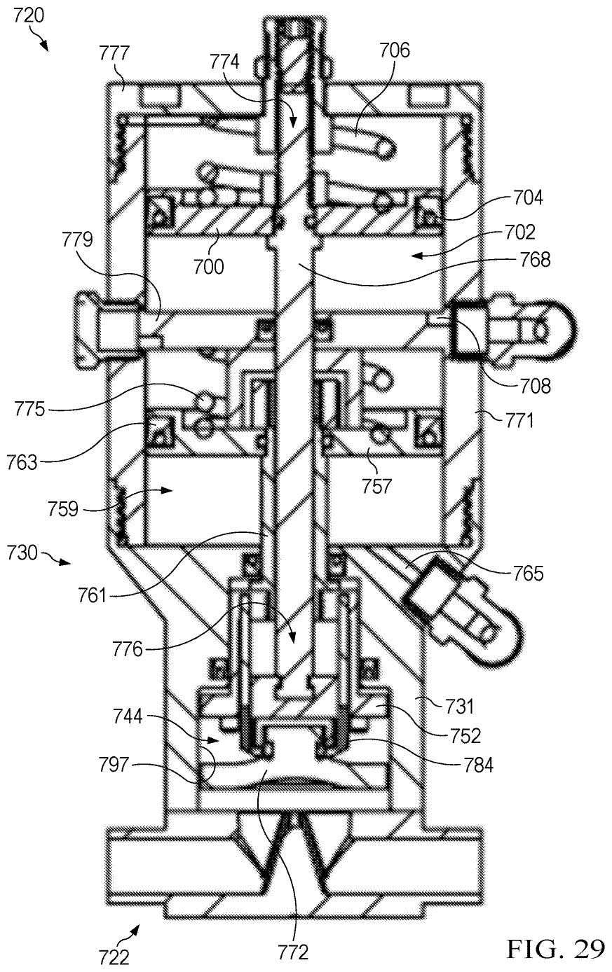

As illustrated in FIGS. 28 and 29, the lower piston 757, the valve sleeve 761, and the perimeter compressor 752 can be slidable together between an extended position (FIG. 28) and a retracted position (FIG. 29). A piston ring 763 can be interposed between the lower piston 757 and the piston housing 771 to allow for sliding of the lower piston 757 relative to the piston housing 771 between the extended and retracted positions. A spring 775 can be provided between the lower piston 757 and the piston housing 771 to bias the lower piston 757 into the extended position.

The lower piston 757 can be pneumatically actuated to facilitate sliding of the perimeter compressor 752 between the extended position and the retracted position. The piston housing 771 can define a fluid port 765 that is in fluid communication with the lower piston chamber 773 to allow for fluid (e.g., air) to be selectively introduced into the lower piston chamber 773 to pressurize the volume between the lower piston 757 to thereby actuate the lower piston 757 between the extended and retracted positions.

The fluid ports 708, 765 can be coupled with a pneumatic system (not shown) that allows for automated control of the upper and lower pistons 700, 757 for fully automated operation of the actuator assembly. For example, the pneumatic system can automatically slide the upper piston 700 between the extended and retracted positions to facilitate automated opening and closing of the sealing member 772. When maintenance is to be performed on the sealing member 772, the pneumatic system can automatically slide the piston 757 and the perimeter compressor 752 into the retracted positions thus freeing the sealing member 772. The pneumatic system can actuate the upper piston 700 to retract the sealing member 772 far enough that the sealing member 772 can be removed from the tip portion 784. Once the sealing member 772 has been successfully replaced, the pneumatic system can remove the pressure from the upper piston 700 which extends the actuator shaft 768 and positions the new sealing member against the valve body 722. Once the new sealing member is positioned properly, the pneumatic system can remove the pressure from the piston 757 to allow for the perimeter compressor 752 to return to the extended position and compress the new sealing member. In one embodiment, the sealing member 772 can be replaced manually by the user. In another embodiment, the sealing member 772 can be automatically replaced by an automated system which allows for automatic replacement of the sealing member 772 as will be described in further detail below.

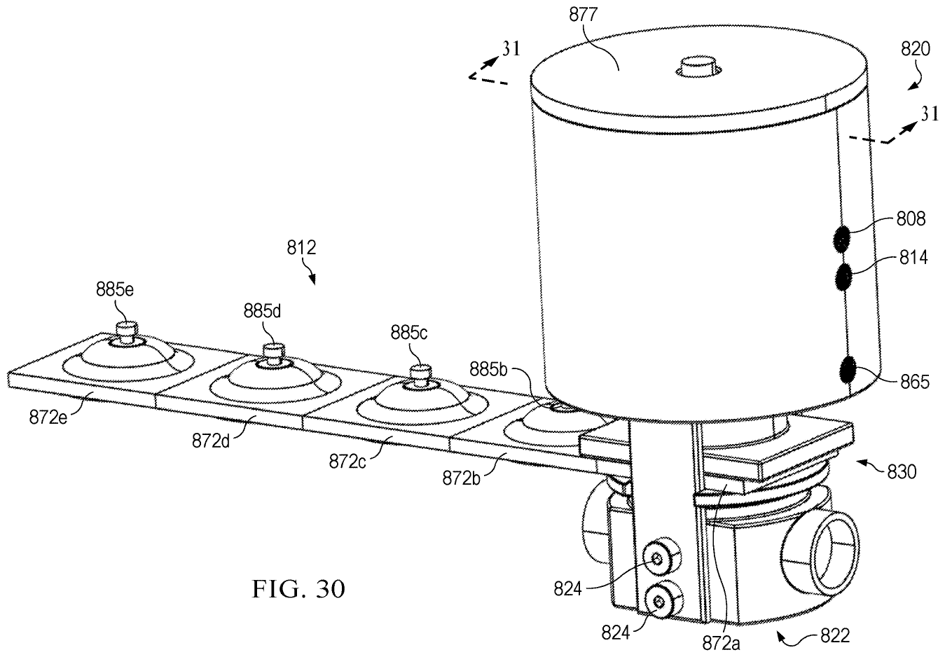

FIGS. 30-35 illustrate yet another alternative embodiment of an actuator assembly 820 that can be similar to, or the same in many respects as, the actuator assemblies 20, 120, 220, 320, 420, 520, 620, 720 illustrated in FIGS. 1-29. For example, as illustrated in FIG. 30, the actuator assembly 820 can be associated with a valve body 822 and can include a main body 830, and a perimeter compressor 852. The valve body 822 can be releasably attached to the main body 830 via fasteners 824 but can alternatively be permanently coupled thereto. The main body 830 can cooperate with the valve body 822 to define an installation window 897a and a removal window 897b that are spaced from each other and disposed on opposite sides of the actuator assembly 820. The main body 830 can include a piston housing 871. However, a plurality of sealing members 872a, 872b, 872c, 872d, 872e are shown to be provided that are interconnected together to form a strip 812. As will be described in further detail below, the strip 812 can be selectively advanced through the actuator assembly 820 to allow for simple and repeatable replacement of the sealing members 872a, 872b, 872c, 872d, 872e on the actuator assembly 820.

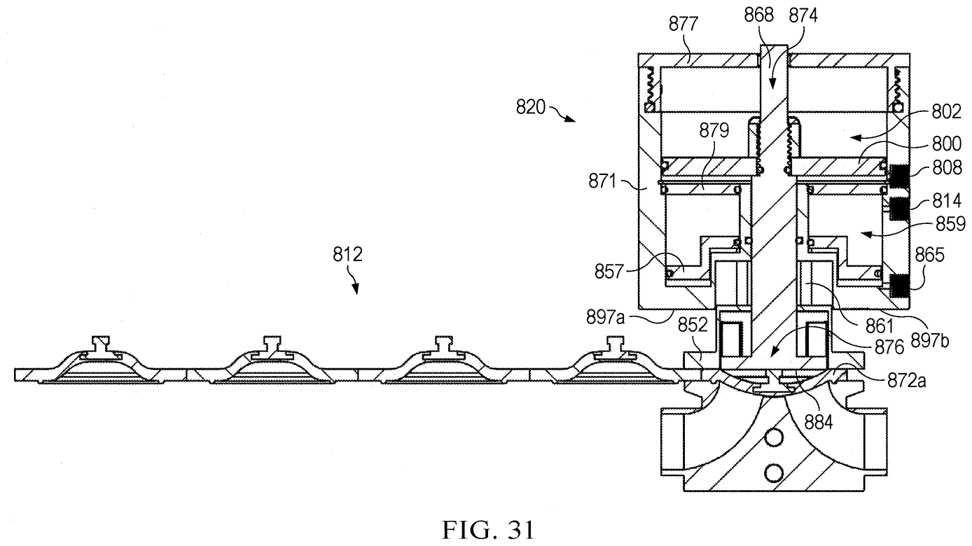

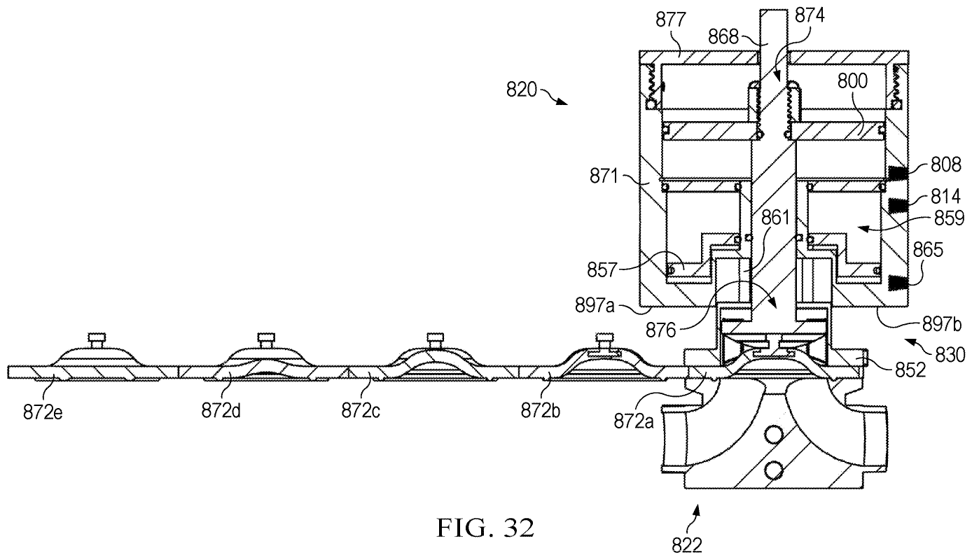

As illustrated in FIG. 31, the piston housing 871 can include a cap 877 and a partition 879. The cap 877 can be threadedly coupled with the rest of the piston housing 871 and with a seal (e.g., an O-ring) provided therebetween for sealing the threaded interface. An actuator shaft 868 can extend through each of the main body 830 and the piston housing 871 and can be coupled at a distal end 876 to the sealing member 872a. The actuator shaft 868 can include a tip portion 884 at the distal end 876 that is releasably coupled with the sealing member 872a. An upper piston 800 can be operably coupled with a proximal end 874 of the actuator shaft 868 and disposed in an upper piston chamber 802 defined by the piston housing 871, the cap 877, and the partition 879. As illustrated in FIGS. 31 and 32, the upper piston 800 and the actuator shaft 868 can be slidable together between an extended position (FIG. 31) and a retracted position (FIG. 32) to facilitate selective closing and opening of the sealing member 872a.

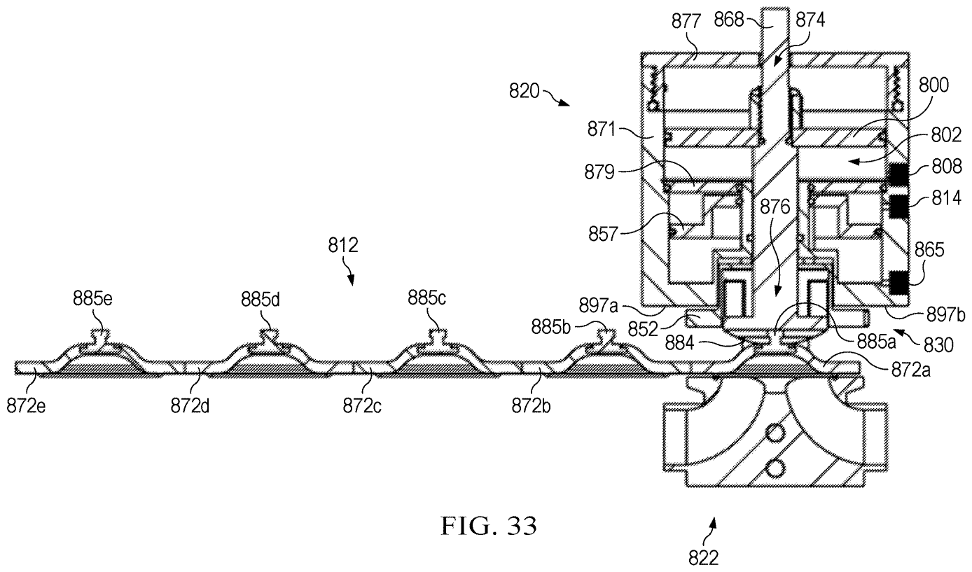

A lower piston 857 can be operably coupled with the perimeter compressor 852 and disposed in a lower piston chamber 873 that is defined by the piston housing 871, the piston housing 871, and the partition 879 such that the partition separates the upper piston chamber 802 from the lower piston chamber 873. The lower piston 857 can be coupled to a valve sleeve 861 which is in turn coupled with the perimeter compressor 852. As illustrated in FIGS. 32 and 33, the lower piston 857, the valve sleeve 861, and the perimeter compressor 852 can be slidable together between an extended position (FIG. 32) and a retracted position (FIG. 33) to facilitate corresponding sliding of the perimeter compressor 852 between the extended and retracted positions with respect to the valve body 822.

The piston housing 871 can define a fluid port 808 that is in fluid communication with the upper piston chamber 802 to allow for fluid (e.g., air) to be selectively introduced into upper piston chamber 802 between the upper piston 800 and the partition 879 to pressurize the volume therebetween to slide the upper piston 800 into the retracted position thus opening the sealing member 872a. However, in lieu of a spring (e.g., 706), a fluid port (not shown) can be in fluid communication with the volume between the upper piston 857 and the cap 877 to allow for fluid (e.g., air) to pressurize the volume to facilitate sliding of the upper piston 800 and the actuator shaft 868 into the extended position thus closing the sealing member 872a. The piston housing 871 can define a fluid port 865 that is in fluid communication with the lower piston chamber 873 to allow for fluid (e.g., air) to pressurize the volume between the lower piston 857 and the piston housing 871 to slide the lower piston 857 into the retracted position. However, in lieu of a spring (e.g., 765), the piston housing 871 can define a fluid port 814 that is in fluid communication with the volume between the lower piston 857 and the partition 879 to allow for fluid (e.g., air) to pressurize the volume to slide the lower piston 857 and perimeter compressor 852 into the extended position.

Referring again to FIG. 30, each of the sealing members 872a, 872b, 872c, 872d, 872e of the strip 812 can be interconnected and positioned relative to each other such that each of the sealing members 872a, 872b, 872c, 872d, 872e are substantially aligned relative to each other. In one embodiment, the sealing members 872a, 872b, 872c, 872d, 872e can be interconnected by a living hinge such that each of the sealing members 872a, 872b, 872c, 872d, 872e are pivotable relative to adjacent sealing members. The sealing members 872a, 872b, 872c, 872d, 872e can include respective studs 885a, 885b, 885c, 885d, 885e (e.g., a key) that can be configured to slide into and out of engagement with the tip portion 884 during installation and removal. As such, the sealing members 872a, 872b, 872c, 872d, 872e can be installed sequentially and in order onto the tip portion 884 as replacements for a previously installed sealing member (e.g., a used sealing member).

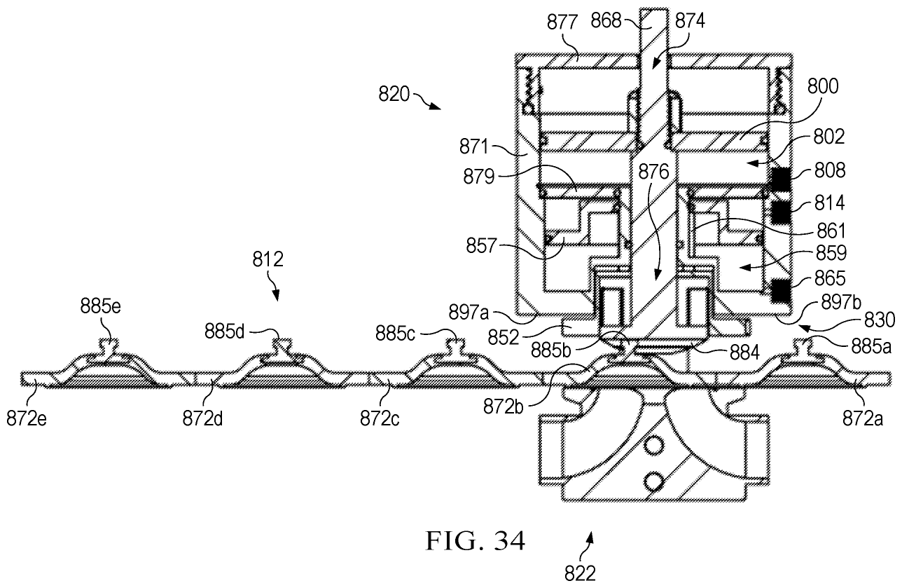

Referring now to FIGS. 31-35, the installation of sequential ones of the sealing members 872a, 872b, 872c, 872d, 872e onto the tip portion 884 will now be described. FIGS. 31 and 32 illustrate the strip extending through the installation window 897a such that the sealing member 872a is installed on the tip portion 884 and is therefore in-service. While the sealing member 872a is in-service, the perimeter compressor 852 can remain in the extended position and the sealing member 872a can be actuated between the closed position (FIG. 31) and the opened position (FIG. 32) through actuation of the upper piston 800. When the sealing member 872a is no longer serviceable and needs to be replaced, the actuator shaft 868 and the perimeter compressor 852 can be slid into their respective retracted positions, as illustrated in FIG. 33, to take the sealing member 872a out of service. The strip 812 can then be slid (i.e., fed) further through into the installation window 897a which can slidably force the stud 885a of the sealing member 872a out of engagement with the tip portion 884 such that the sealing member 872a is slid through the removal window 897b while simultaneously introducing the sealing member 872b through the installation window 897a as a new sealing member such that the stud 885b is engaged with the tip portion 884, as illustrated in FIG. 34. In some embodiments, such sliding of the strip 812 can cause an annular rib (e.g., 91) of the sealing member 872a to be disengaged from an annular groove (e.g., 92) on the valve body 822. It is to be appreciated that sliding the actuator shaft 868 into the extended position can be position the tip portion 884 in such a manner that allows the stud 885a of the sealing member 872a to be slid out of engagement with the tip portion 884 and the stud 885b of the sealing member 872b to be slid into engagement with the tip portion 884 as a function of simply sliding the strip 812 further into the installation window 897a.

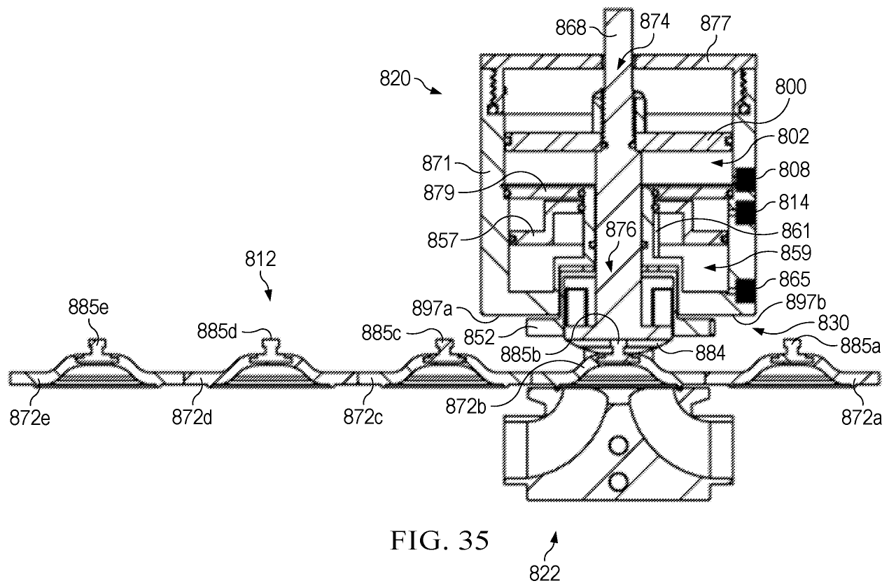

The strip 812 can continue to be advanced through the installation window 897a until the stud 885b and the sealing member 872b are fully installed onto the tip portion 884, as illustrated in FIG. 35. With the sealing member 872b installed on the tip portion 884, the perimeter compressor 852 can be slid into the extended position (see FIG. 32), to place the sealing member 872b in service. In some embodiments, sliding of the perimeter compressor 852 into the extended position can cause an annular rib (e.g., 91) of the sealing member 872b to be engaged with an annular groove (e.g., 92) on the valve body 822. Once the sealing member 872b is placed in service, the actuator shaft 868 can be slid between the extended and retracted positions to facilitate closing and opening of the sealing member 872b relative to the valve body 822. This process can be repeated for the remaining ones of the sealing members 872c, 872d, 872e from the strip 812 to replace a previously installed sealing member. In some embodiments, the strip 812 can be advanced manually through the actuator assembly 820 by a user. In other embodiments, the strip 812 can be advanced automatically as part of an automated system, as will be described in further detail below. It is to be appreciated that, although the strip 812 is shown to include five sealing members, any quantity of sealing members are contemplated for a particular strip. It is also to be appreciated that the actuation of the upper and lower pistons 800, 857 can be fully automated such that the sealing members can be easily replaced without requiring full disassembly of the actuator assembly 820 which can be time consuming, expensive and oftentimes can require a full plant shutdown.

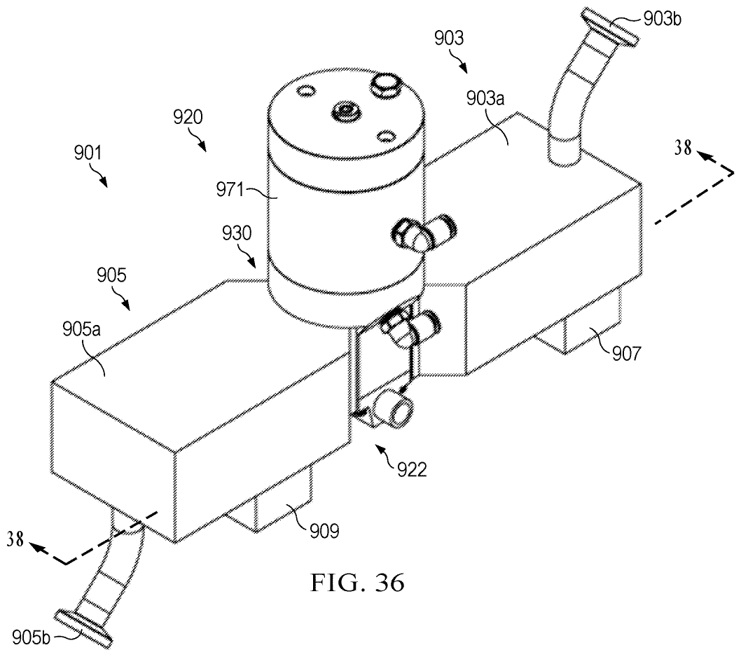

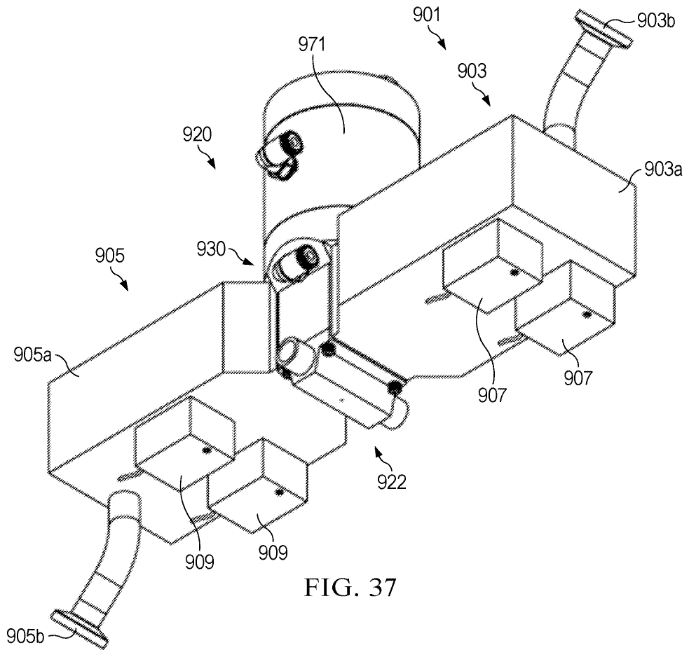

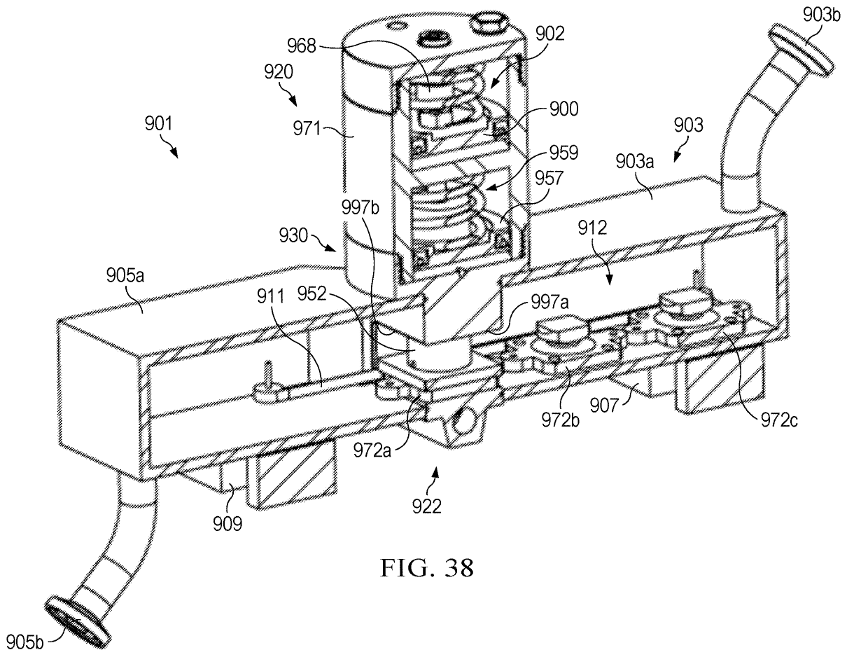

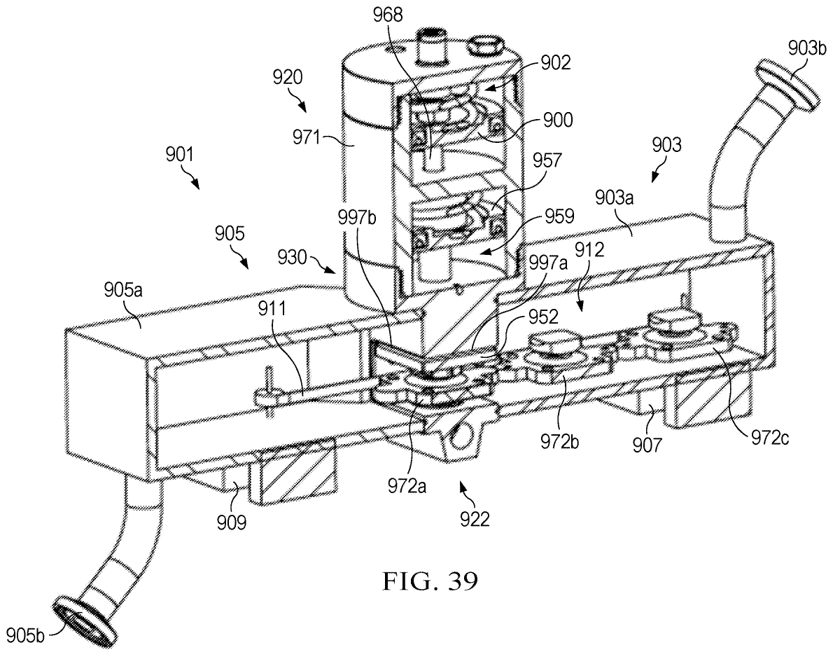

FIGS. 36-41 illustrate a conveyance system 901 that is incorporated onto an actuator assembly 920 that can be similar to, or the same in many respects as, the actuator assemblies 620, 720, 820 illustrated in FIGS. 21-35. For example, as illustrated in FIGS. 36 and 37, the actuator assembly 920 can be associated with a valve body 922 and can include a main body 930 that includes a piston housing 971. As illustrated in FIG. 38, the main body 930 can cooperate with the valve body 922 to define an installation window 997a and a removal window 997b that are spaced from each other and disposed on opposite sides of the actuator assembly 920. The actuator assembly 920 can include an upper piston 900 that is operably coupled with an actuator shaft 968 and disposed in an upper piston chamber 902. A lower piston 957 can be operably coupled with a perimeter compressor 952 and disposed in a lower piston chamber 973. As illustrated in FIGS. 38 and 39, the upper piston 900 and the actuator shaft 968 can be slidable together between an extended position (FIG. 38) and a retracted position (FIG. 39). The lower piston 957 and the perimeter compressor 952 can be slidable together between an extended position (FIG. 38) and a retracted position (FIG. 39).

Referring again to FIGS. 36 and 37, the conveyance system 901 can include a feeder assembly 903 that includes a housing 903a and a collection assembly 905 that includes a housing 905a. These housings 903a, 905a can be releasably attached to actuator assembly 920 with fasteners (e.g., bolts) or any variety of suitable alternative arrangements. The interfaces between the housings 903a, 905a can be sealed with a gasket (e.g., O-ring) or any of a variety of suitable alternative arrangements. As illustrated in FIG. 37, the feeder assembly 903 can include a pair of feeder servos 907 and the collection assembly 905 can include a pair of collection servos 909. As illustrated in FIG. 38, a drive belt 911 can be routed between one of the feeder servos 907 and one of the collection servos 909 on one side of the conveyance system 901. A corresponding drive belt (not shown) can be routed between the other feeder servo 907 and the collection servo 909 located on the opposite side of the conveyance system 901. A strip 912 of sealing members 972a, 972b, 972c can be provided between the drive belts (e.g., 911) and can be frictionally engaged with the drive belts such that the drive belts are capable of sliding the strip 912 relative to the actuator assembly 920. As will be described in further detail below, the feeder servos 907 and the collection servos 909 can be operable to selectively drive the drive belts in the direction of the collection servos to facilitate installation of sequential ones of the sealing members 972a, 972b, 972c onto the actuator shaft 968.

The housings 903a, 905a can include respective fluid ports 903b, 905b that cooperate to allow for the introduction of fluid into the interior of the conveyance system 901 and for draining therefrom to effectively clean the interior. In one embodiment, the fluid can include any cleaning, sanitizing, sterilizing, decontaminating or neutralizing agents. Cleaning the interior in this manner can protect a sanitary and hazardous process (such as may be used to vaccine production) by first cleaning the interior before accessing the interior (i.e., to replace the strip 912) and also cleaning the interior after it has been accessed to remove any contaminants.

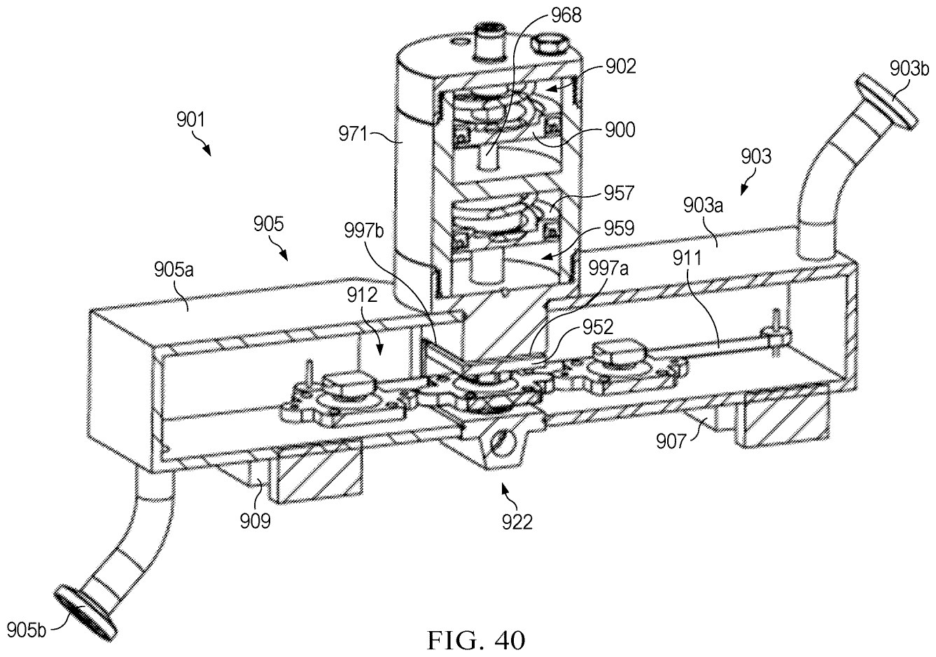

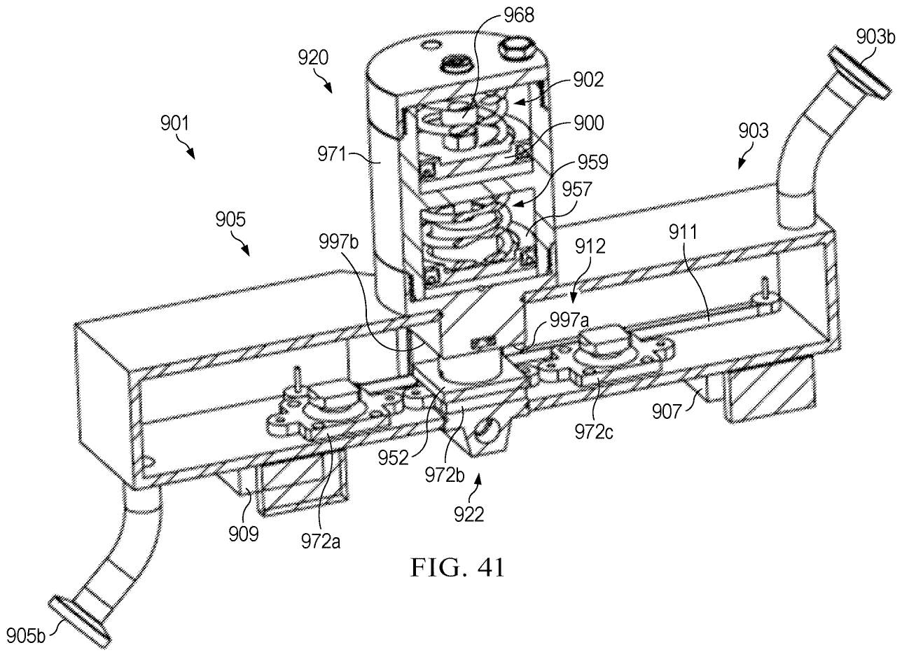

Referring now to FIGS. 38-41, the operation of the feeder servos 907 and the collection servos 909 to facilitate installation of sequential ones of the sealing members 972a, 972b, 972c onto the actuator shaft 968 will now be described. FIG. 38 illustrates the strip 912 extending through the installation window 997a such that the sealing member 972a is installed on the actuator shaft 968 and is therefore in-service. While the sealing member 972a is in-service, the perimeter compressor 952 can be in the extended position and the sealing member 972a can be actuated between the closed position and the opened position through actuation of the upper piston 900. When the sealing member 972a is no longer serviceable and needs to be replaced, the actuator shaft 968 and the perimeter compressor 952 can be slid into their respective retracted positions, as illustrated in FIG. 39, to take the sealing member 972a out of service. The feeder servos 907 and the collection servos 909 can then be actuated to the strip 912 to be fed further through the installation window 997a which can force the sealing member 972a out of engagement with the actuator shaft 968 and through the removal window 997b while simultaneously introducing the sealing member 972b through the installation window 897a as a new sealing member and into engagement with the actuator shaft 968, as illustrated in FIG. 40. With the sealing member 972b installed on the actuator shaft 968, the perimeter compressor 952 can be slid into the extended position, as illustrated in FIG. 41, to place the sealing member 972b in service. Once the sealing member 972b is placed in service, the actuator shaft 968 can be slid between the retracted and extended positions to facilitate opening and closing of the sealing member 872b relative to the valve body 822. This process can be repeated for the remaining sealing member 872c from the strip 812 to replace a previously installed sealing member. The conveyance system 901 can cooperate with the actuator assembly 920 to provide a fully automated solution for replacing sealing members on the actuator assembly 920 without requiring full disassembly of the actuator assembly 920 and without requiring physical interaction with the actuator assembly which can be time consuming, expensive and oftentimes can require a full plant shutdown.

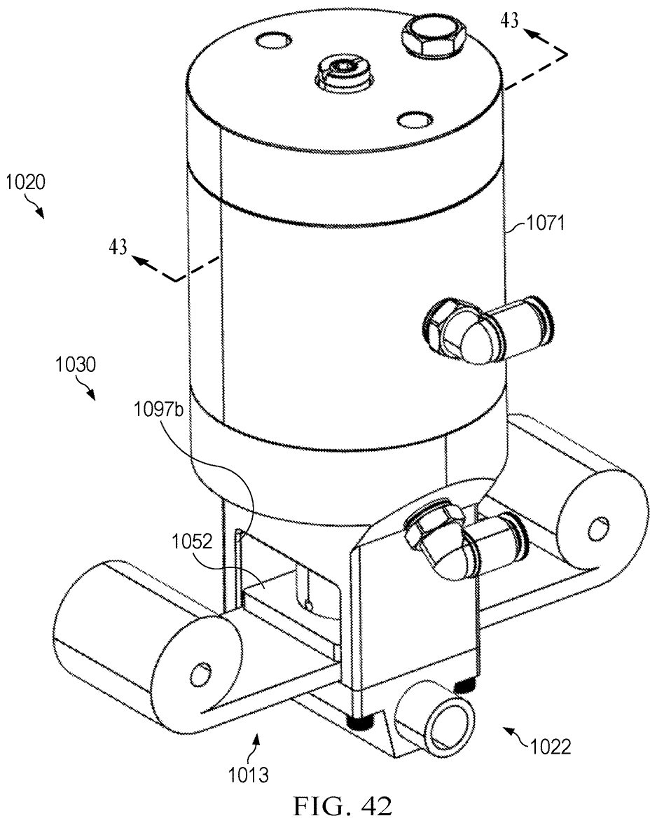

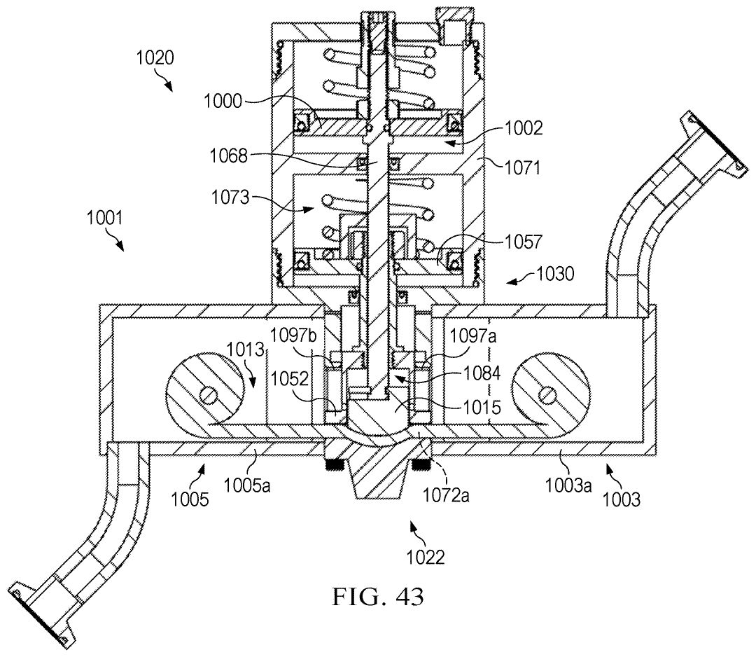

FIGS. 42-45 an actuator assembly 1020 that can be similar to, or the same in many respects as, the actuator assemblies 620, 720, 820, 920 illustrated in FIGS. 21-41. For example, as illustrated in FIGS. 42 and 43, the actuator assembly 1020 can be associated with a valve body 1022 and can include a main body 1030 a perimeter compressor 1052. The main body 1030 can cooperate with the valve body 1022 to define an installation window 1097a and a removal window 1097b that are spaced from each other and disposed on opposite sides of the actuator assembly 1020. The main body 1030 can include a piston housing 1071. A conveyance system 1001, as illustrated in FIG. 43, can be incorporated onto the actuator assembly 1020 and can include a feeder assembly and housing 1003, 1003a and a collection assembly and housing 1005, 1005a. However, a continuous belt of sealing material (e.g., continuous belt 1013) is shown to be routed through the installation and removal windows 1097a, 1097b and spooled together on opposite ends such that the continuous belt 1013 can be sequentially fed through the installation and removal windows 1097a, 1097b via a reel-to-reel process, as will be described in further detail below.

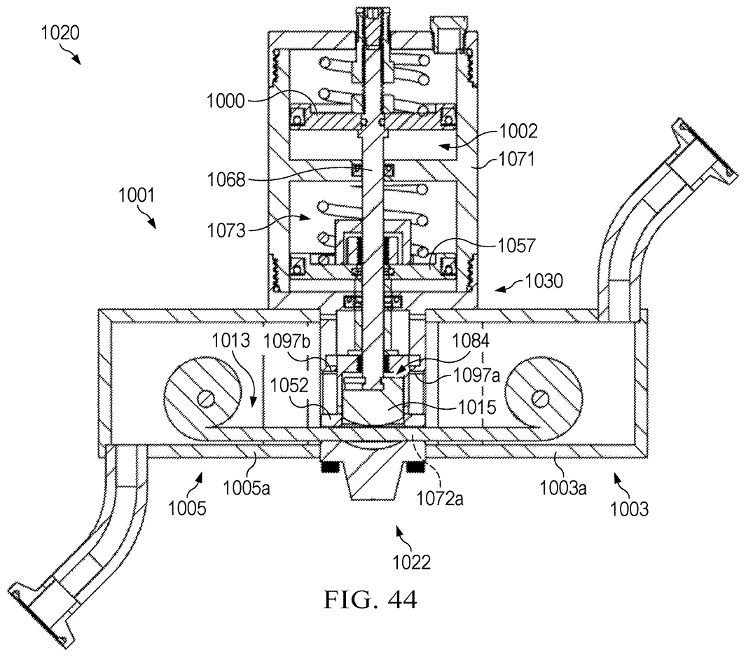

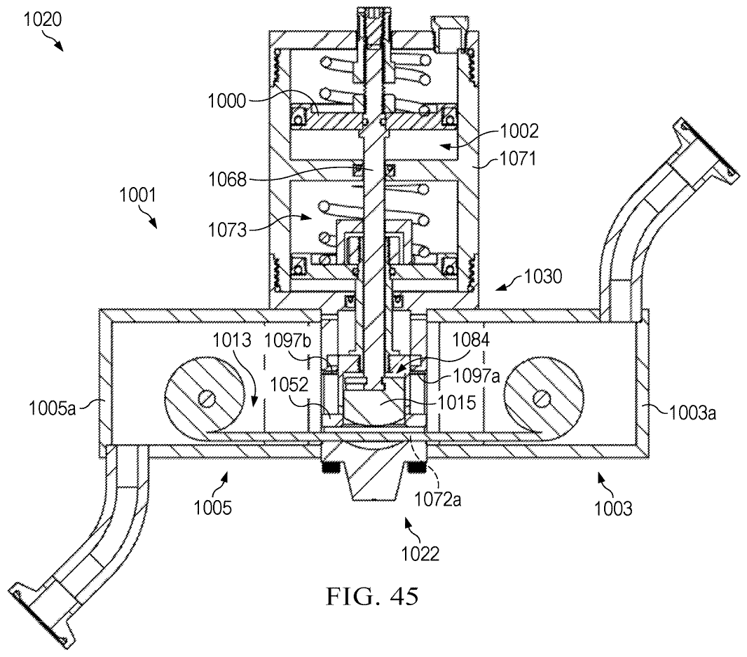

As illustrated in FIG. 43, an actuator shaft 1068 can extend through each of the main body 1030 and the piston housing 1071 and a tip portion 1084. An upper piston 1000 can be operably coupled with the actuator shaft 1068 and disposed in an upper piston chamber 1002 of the piston housing 1071. A lower piston 1057 can be operably coupled with the perimeter compressor 1052 and disposed in a lower piston chamber 1073 of the piston housing 1071. The tip portion 1084, however, can include a plunger 1015 that interacts with the continuous belt 1013 to selectively seal the valve body 1022, as will be described in further detail below. As illustrated in FIGS. 43 and 44, the upper piston 1000 and the actuator shaft 1068 can be slidable together between an extended position (FIG. 43) and a retracted position (FIG. 44). The lower piston 1057 and the perimeter compressor 1052 can be slidable together between an extended position (FIG. 44) and a retracted position (FIG. 45).

As illustrated in FIGS. 43 and 44, the perimeter compressor 1052 is shown to be in the extended position which sandwiches a portion of the continuous belt 1013 between the perimeter compressor 1052 and the valve body 1022 which can serve as a sealing member (e.g., 1072a outlined in dashed lines). For example, when the actuator shaft 1068 is in the extended position, as illustrated in FIG. 43, the plunger 1015 can urge the sealing member 1072a into contact with the valve body 1022 (e.g., in a closed position) which essentially temporarily deforms the sealing member 1072a. When the actuator shaft 1068 is slid to the retracted position, as illustrated in FIG. 44, the plunger 1015 can be retracted far enough to space the plunger 1015 from the sealing member 1072a which allows the sealing member 1072a to naturally return to its non-deformed condition (e.g., due to the pliability of the material) and thus out of contact with the valve body 1022 (e.g., to an opened position). The plunger 1015 can accordingly cooperate with the continuous belt to allow for different portions of the continuous belt 1013 to be used as a sealing member without requiring attachment of the different portions to the plunger 1015 (e.g., with a stud/rail or key/keyway configuration described in the previous embodiments).

The continuous belt 1013 can be sequentially fed through the installation and removal windows 1097a, 1097b to allow for different portions of the continuous belt 1013 to be utilized as a new sealing member. FIG. 43 shows the sealing member 1072a sandwiched between the perimeter compressor 1052 and therefore in-service. While the sealing member 1072a is in-service, the perimeter compressor 1052 can remain in the extended position and the sealing member 1072a can be flexed between the closed position (FIG. 43) and the opened position (FIG. 44) by the plunger 1015. When the sealing member 1072a is no longer serviceable and needs to be replaced, the actuator shaft 1068 and the perimeter compressor 1052 can be slid into their respective retracted positions, as illustrated in FIG. 45, to take the sealing member 1072a out of service. The continuous belt 1013 can then be advanced (i.e., fed) through the installation window 1097a enough to present a new portion of the continuous belt 1013 beneath the perimeter compressor 1052 while simultaneously sliding the old the sealing member 1072a past the perimeter compressor 1052 and through the window. In one embodiment, each of the spools at opposite ends of the continuous belt 1013 include respective spooling motors (not shown) that rotate the spools simultaneously in a direction that allows for one of the spools to dispense the continuous belt 1013 and the other spool to collect the continuous belt 1013 (e.g., in a reel-to-reel configuration). With a new portion of the continuous belt 1013 presented beneath the perimeter compressor 1052, the perimeter compressor 1052 can be slid into the extended position, as illustrated in FIG. 44, to sandwich the new portion of the continuous belt 1013 between the perimeter compressor 1052 and the valve body 1022 such that the new portion can now serve as a sealing member. This process can be repeated for the entire length of the continuous belt 1013. It is to be appreciated that since the plunger 1015 does not require attachment of the continuous belt 1013 thereto to provide a sealing member (e.g., with a stud/rail or key/keyway configuration described in the previous embodiments), the continuous belt 1013 can be agnostic relative to the positioning of the next sealing member beneath the perimeter compressor 1052.

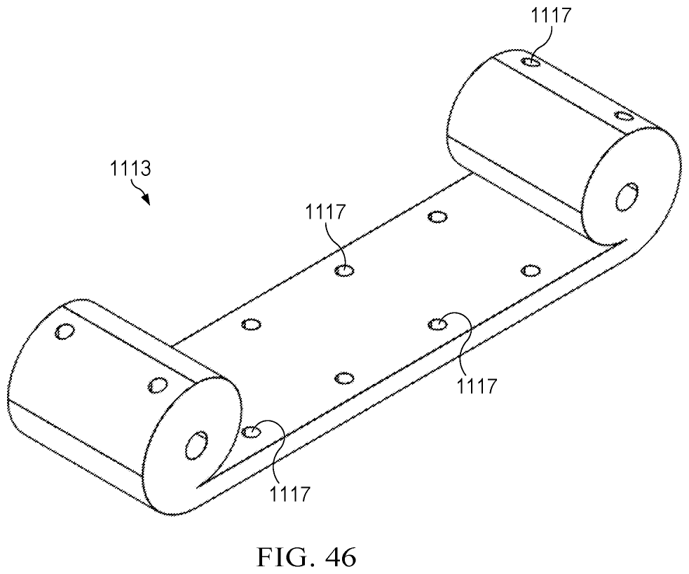

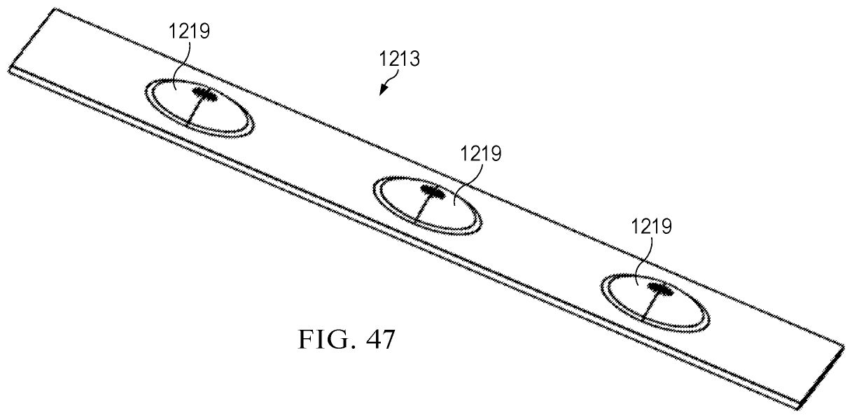

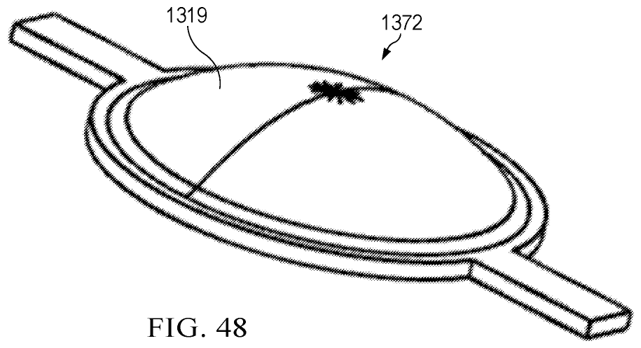

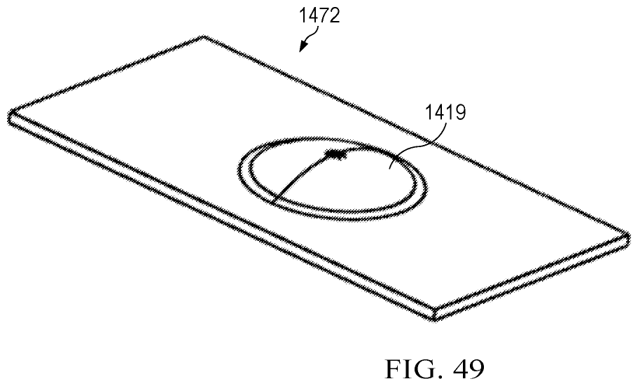

FIGS. 46-49 illustrate various alternative sealing arrangements embodiments that can be used as a replacement for the continuous belt 1013 shown in FIGS. 42-45. FIG. 46 illustrates a continuous belt 1113 that is similar to, or the same in many respects as, the continuous belt 1013 but can further include a plurality of guide holes 1117 that aid in the conveyance and alignment of the continuous belt 1113 during feeding of the continuous belt 1113 though the actuator assembly 1020. FIG. 47 illustrates a continuous belt 1213 that is similar to, or the same in many respects as, the continuous belt 1013 but can include a plurality of preformed domes 1219 that are able to register with the plunger 1015 during feeding of the continuous belt 1213 though the actuator assembly 1020. FIGS. 48 and 49 illustrate separate sealing elements 1372, 1472 each include a respective dome 1319, 1419 that can be individually installed on the actuator assembly 1020 beneath the plunger in lieu of the continuous belt 1013.

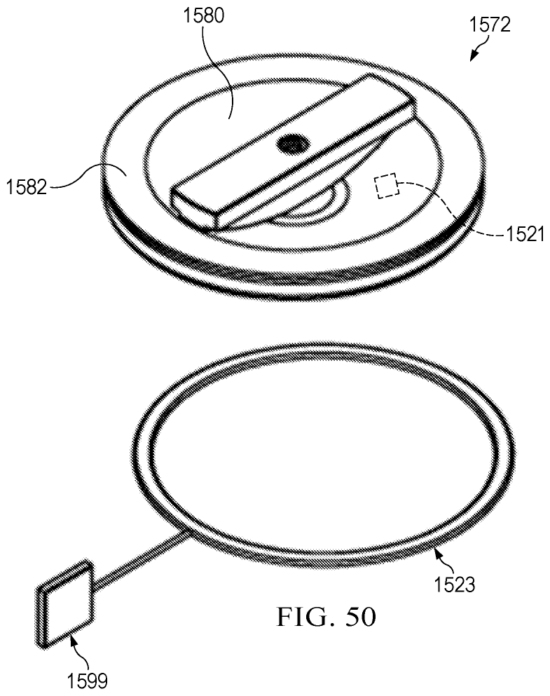

FIG. 50 illustrates a sealing member 1572 that can be similar to, or the same in many respects as, the sealing members described above. For example, the sealing member 1572 can include an inner portion 1580 and an outer portion 1582. However, the sealing member 1572 can include a sensor 1521 facilitates detection of one or more operational parameters of the sealing member 1572 and/or environmental parameters the surrounding environment, such as for example, temperature, pressure, moisture content, deflection of the sealing member, electrical or chemical potential, or time in service. It is to be appreciated that although the sensor 1521 is shown to be disposed on the inner portion 1580, the sensor 1521 might be embedded in the sealing member 1572 and/or can be provided in any of a variety of locations on the sealing member 1572 such as, for example, on the outer portion 1582, along a perimeter of the outer portion 1582, or centered on the inner portion 1580 to monitor the performance of a stud or other securement arrangement. The sealing member 1572 can also be equipped with a microprocessor (not shown) that processes the data gathered from the sensor 1521 to facilitate generation of a notification to a user, either onboard the sealing member 1572 or remote from the sealing member 1572 (e.g., on a smartphone or other remote computing device) of the status of the sensed parameter. The sealing member 1572 might also include a wireless communication module (not shown) that facilitates wireless communication with a remote computing device. The sealing member 1572 might further include an onboard power source, such as a battery, that facilitates powering of the electrical devices (e.g., the sensor 1521, the microprocessor, and/or the wireless communication module). The sealing member 1572 might additionally or alternative include RFID capabilities. In one embodiment, the sealing member 1572 can include a data ring 1523 that is provided along an outer perimeter of the sealing member and includes the microprocessor, the wireless communication module, and the power source for the sensor 1521. One or more of microprocessor, the wireless communication module, or the onboard power source can be located in the data ring 1523 or in a tab portion 1599 that extends outwardly from the data ring 1523 outer portion 1582.

The foregoing description of embodiments and examples has been presented for purposes of illustration and description. It is not intended to be exhaustive or limiting to the forms described. Numerous modifications are possible in light of the above teachings. Some other examples of the modifications that are possible are illustrated in U.S. provisional patent application Ser. No. 63/175,612, which is incorporated by reference herein in its entirety. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

1. An actuator assembly configured for attachment to a valve body, the actuator assembly comprising:
a main body comprising a piston housing defining a first piston chamber;
a sealing member configured to interface with the valve body to provide a seal therebetween;
a perimeter compressor disposed adjacent to the piston housing and that overlies the sealing member, the perimeter compressor being slidable with respect to the main body between a retracted position and an extended position; and
a first piston disposed in the first piston chamber and operably coupled with the perimeter compressor such that the first piston is slidable together with the perimeter compressor between the extended position and the retracted position of the perimeter compressor, wherein:
sliding of the perimeter compressor into the extended position imparts a downward force onto the sealing member; and
sliding of the perimeter compressor into the retracted position facilitates releasement of the downward force from the sealing member.

2. The actuator assembly of claim 1 further comprising an actuator shaft that extends through at least a portion of the piston housing and that is slidable with respect to the piston housing between an extended position and a retracted position wherein the actuator shaft comprises a proximal end and a distal end, and the sealing member is releasably coupled with the distal end of the actuator shaft.

3. The actuator assembly of claim 2 further comprising an actuator operably coupled with the proximal end of the actuator shaft and configured to facilitate sliding of the actuator shaft between the extended position and the retracted position.

4. The actuator assembly of claim 1 wherein the sealing member comprises an inner portion and an outer portion that extends radially therefrom.

5. The actuator assembly of claim 4 wherein the perimeter compressor overlies the outer portion of the sealing member.

6. The actuator assembly of claim 3 wherein:
the piston housing further defines a second piston chamber adjacent to the first piston chamber; and
the actuator further comprises a second piston disposed in the first piston chamber and coupled with the proximal end of the actuator shaft such that the first piston is slidable together with the actuator shaft between the extended position and the retracted position.

7-10. (canceled)

11. The actuator assembly of claim 1 wherein:
the main body defines an interior receptacle; and
the perimeter compressor is disposed at least partially in the interior receptacle.

12-13. (canceled)

14. The actuator assembly of claim 11 wherein:
the main body further comprises a side wall that at least partially defines the interior receptacle; and
the side wall defines at least one access window.

15-24. (canceled)

25. A system comprising:
a valve actuator assembly comprising:
a valve body comprising a sealing interface;
a main body coupled with the valve body and defining an interior chamber, a first window, and a second window that is spaced from the first window, the first window and the second window being configured to provide access to the interior chamber;
an actuator shaft comprising a proximal end and a distal end and that extends through the main body such that the distal end is more proximate the valve body than the proximal end, the actuator shaft being slidable with respect to the main body between an extended position and a retracted position;
an actuator operably coupled with the proximal end of the actuator shaft and configured to facilitate sliding of the actuator shaft between the extended position and the retracted position;
a perimeter compressor that overlies the sealing interface and is slidable with respect to the main body between a retracted position and an extended position;
a plurality of sealing members, each sealing member of the plurality of sealing members being configured for association with the actuator shaft;
a feeder assembly that is associated with the first window of the valve actuator assembly and houses the plurality of sealing members, the feeder assembly being configured to introduce each of the sealing members individually through the first window and to the actuator shaft to facilitate installation of each of the sealing members, sequentially and in order, relative to the actuator shaft as a replacement for a used sealing member previously installed on the actuator shaft.

26. The system of claim 25 wherein the introduction of each sealing member onto the actuator shaft simultaneously forces a used sealing member off the actuator shaft and through the second window.

27-28. (canceled)

29. The system of claim 25 wherein:
the main body comprises a pair of side walls and a piston housing disposed adjacent to the pair of sidewalls, wherein the pair of side walls cooperate to at least partially define the interior receptacle, each side wall of the pair of side walls defines one of the first window and the second window, and the piston housing defines a first piston chamber; and
the valve actuator assembly further comprises a first piston is disposed in the first piston chamber and is operably coupled with the perimeter compressor such that the first piston is slidable together with the perimeter compressor between the extended position and the retracted position.

30-37. (canceled)

38. The system of claim 25 further comprising a collection assembly that is associated with the second window of the valve actuator assembly and is configured to collect the used sealing members that are provided through the second window.

39. (canceled)

40. The system of claim 38 wherein:
the feeder assembly comprises a feeder reel;
the collection assembly comprises a collection reel;
the plurality of sealing members are interconnected together to form a continuous strip of sealing members that are spooled onto the feeder reel;
the feeder reel is operable to dispense the continuous strip of sealing members through the first window; and
the collection reel is configured to collect the used sealing members of the continuous strip of sealing members from the second window as a spool.

41-50. (canceled)

51. An actuator assembly configured for attachment to a valve body, the actuator assembly comprising:
an actuator shaft slidable between an extended position and a retracted position, the actuator shaft comprising a proximal end and a distal end;
a sealing member comprising an inner portion and an outer portion that extends from the inner portion, the inner portion being associated with the distal end of the actuator shaft such that the distal end of the actuator shaft is configured to selectively interact with the inner portion to actuate the sealing member between an opened position and a closed position; and
a perimeter compressor associated with the sealing member, the perimeter compressor being slidable relative to the actuator shaft between a retracted position and an extended position, wherein:
sliding of the perimeter compressor into the extended position engages the perimeter compressor with the outer portion of the sealing member; and
sliding of the perimeter compressor into the retracted position disengages the perimeter compressor from the outer portion of the sealing member.

52. The actuator assembly of claim 51 further comprising an actuator operably coupled with the proximal end of the actuator shaft and configured to facilitate sliding of the actuator shaft between the extended position and the retracted position.

53. The actuator assembly of claim 52 wherein the actuator comprises a means for automating sliding of the actuator shaft between the extended position and the retracted position.

54. The actuator assembly of claim 53 wherein the actuator comprises a piston that is operably coupled with the actuator shaft and is pneumatically actuated to facilitate selective sliding of the actuator shaft between the extended position and the retracted position.

55. The actuator assembly of claim 52 further comprising an actuator operably coupled with the perimeter compressor and configured to facilitate sliding of the perimeter compressor between the extended position and the retracted position.

56. The actuator assembly of claim 55 wherein the actuator comprises a means for automating sliding of the perimeter compressor between the extended position and the retracted position.

57. (canceled)

58. The actuator assembly of claim 51 further comprising:
a first actuator operably coupled with the proximal end of the actuator shaft and configured to facilitate sliding of the actuator shaft between the extended position and the retracted position; and
a second actuator operably coupled with the perimeter compressor and configured to facilitate sliding of the perimeter compressor between the extended position and the retracted position.

59. The actuator assembly of claim 58 wherein:
the first actuator comprises a first means for automating sliding of the actuator shaft between the extended position and the retracted position; and
the second actuator comprises a second means for automating sliding of the perimeter compressor between the extended position and the retracted position.

60-61. (canceled)
